(19) United States
(12) Patent Application Publication
(10) Pub. No.: US 2025/0150250 A1
(43) Pub. Date: May 8, 2025

(54) SEARCH SPACE MONITORING FOR HALF-DUPLEX USER EQUIPMENT

(71) Applicant: QUALCOMM Incorporated, San Diego, CA (US)

(72) Inventors: Le LIU, San Jose, CA (US); Huilin XU, Temecula, CA (US); Yi HUANG, San Diego, CA (US)

(21) Appl. No.: 18/895,168

(22) Filed: Sep. 24, 2024

Related U.S. Application Data
(60) Provisional application No. 63/595,693, filed on Nov. 2, 2023.

(51) Int. Cl. H04L 5/16; H04L 5/00

(52) U.S. Cl. CPC H04L 5/16; H04L 5/0053

(57) ABSTRACT

Methods, systems, and devices for wireless communications are described. A network entity (e.g., a user equipment) may receive information that configures physical downlink control channel (PDCCH) monitoring in a search space set. The network entity may receive control information that indicates an uplink transmission, wherein a collision condition exists between the PDCCH monitoring in the search space set and the uplink transmission. The network entity may perform, during operation in a half-duplex mode, an action in accordance with a collision handling rule, wherein the collision handling rule is based on the collision condition and the search space set.

### CROSS REFERENCE

The present Application for patent claims the benefit of U.S. Provisional Patent Application No. 63/595,693 by LIU et al., entitled “SEARCH SPACE MONITORING FOR HALF-DUPLEX USER EQUIPMENT,” filed on Nov. 2, 2023, and assigned to the assignee hereof. U.S. Provisional Patent Application No. 63/595,693 is expressly incorporated by reference herein in its entirety.

### INTRODUCTION

The following relates to wireless communications, including search space monitoring for half-duplex user equipment.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support search space monitoring for half-duplex user equipment. For example, the described techniques provide for collision handling rules to be applied by a half-duplex network entity (e.g., a user equipment (UE) operating in a half-duplex mode) during a collision condition. For example, the network entity may receive or otherwise obtain information that configures the network entity for physical downlink control channel (PDCCH) monitoring in a search space (SS) set. The network entity may receive or otherwise obtain control information that indicates an uplink transmission. However, a collision condition may exist between the PDCCH monitoring in the SS set and the uplink transmission. This may include the PDCCH monitoring in the SS set and the uplink transmission overlapping, partially or fully, in the time domain. The network entity may apply a collision handling rule to perform an action while operating in the half-duplex mode and based on the collision condition. For example, the collision handling rule may result in the network entity adopting or otherwise applying a network entity-based implementation or solution, or the network entity may assume that the collision condition is an error condition, or the network entity may take some other action. For example, the network entity may perform the PDCCH monitoring in the SS set or may perform the uplink transmission. In some aspects, the collision handling rule may be based on the type of SS set in which the PDCCH monitoring is to be performed (e.g., may provide a collision handling rule applicable for a specific type of SS set being configured for the network entity). Accordingly, the network entity may resolve the collision condition according to the collision handling rule.

A method for wireless communication by a network entity is described. The method may include receiving information that configures PDCCH monitoring in a SS set, receiving control information that indicates an uplink transmission, where a collision condition exists between the PDCCH monitoring in the SS set and the uplink transmission, and performing, during operation in a half-duplex mode, an action in accordance with a collision handling rule, where the collision handling rule is based on the collision condition and the SS set.

A network entity for wireless communication is described. The network entity may include one or more memories storing processor executable code, and one or more processors coupled with the one or more memories. The one or more processors may individually or collectively operable to execute the code to cause the network entity to receive information that configures PDCCH monitoring in a SS set, receive control information that indicates an uplink transmission, where a collision condition exists between the PDCCH monitoring in the SS set and the uplink transmission, and perform, during operation in a half-duplex mode, an action in accordance with a collision handling rule, where the collision handling rule is based on the collision condition and the SS set.

Another network entity for wireless communication is described. The network entity may include means for receiving information that configures PDCCH monitoring in a SS set, means for receiving control information that indicates an uplink transmission, where a collision condition exists between the PDCCH monitoring in the SS set and the uplink transmission, and means for performing, during operation in a half-duplex mode, an action in accordance with a collision handling rule, where the collision handling rule is based on the collision condition and the SS set.

A non-transitory computer-readable medium storing code for wireless communication is described. The code may include instructions executable by a processor to receive information that configures PDCCH monitoring in a SS set, receive control information that indicates an uplink transmission, where a collision condition exists between the PDCCH monitoring in the SS set and the uplink transmission, and perform, during operation in a half-duplex mode, an action in accordance with a collision handling rule, where the collision handling rule is based on the collision condition and the SS set.

In some examples of the method, network entities, and non-transitory computer-readable medium described herein, the SS set may be a type 2A common SS (CSS) set, the PDCCH monitoring may be for monitoring for a paging early indicator (PEI), and the collision handling rule for the type 2A CSS set may be different from a type 2 CSS set collision handling rule.

In some examples of the method, network entities, and non-transitory computer-readable medium described herein, the collision handling rule defines the action as an error condition when a communication type of the uplink transmission may be a dedicated-radio resource control (RRC)-configured uplink transmission and defines the action as based on implementation of the network entity when the communication type may be a non-dedicated-RRC-configured uplink transmission.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as being based on implementation of the network entity and the collision handling rule may be independent from a communication type of the uplink transmission.

In some examples of the method, network entities, and non-transitory computer-readable medium described herein, the collision handling rule defines the action as being based on implementation of the network entity when a communication type of the uplink transmission may be a non-dedicated-RRC-configured uplink transmission and defines the action as performing the uplink transmission when the communication type may be a dedicated-RRC-configured uplink transmission.

In some examples of the method, network entities, and non-transitory computer-readable medium described herein, the SS set may be a type 1A CSS set, the PDCCH monitoring may be for monitoring for a small data transmission (SDT), and the type 1A CSS set may be different from a type 1 CSS set.

In some examples of the method, network entities, and non-transitory computer-readable medium described herein, the collision handling rule defines the action as an error condition when a communication type of the uplink transmission may be a dedicated-RRC-configured uplink transmission and defines the action as based on implementation of the network entity when the communication type may be a non-dedicated-RRC-configured uplink transmission and the collision handling rule for the type 1A CSS set and a type 1 CSS set collision handling rule may be defined jointly.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as based on implementation of the network entity, the collision handling rule may be independent from a communication type of the uplink transmission, and the collision handling rule for the type 1A CSS set and a type 1 CSS set collision handling rule may be defined separately.

In some examples of the method, network entities, and non-transitory computer-readable medium described herein, the collision handling rule defines the action as based on implementation of the network entity, the collision handling rule may be independent from a communication type of the uplink transmission, and the collision handling rule for the type 1A CSS set and a type 1 CSS set collision handling rule may be defined jointly.

In some examples of the method, network entities, and non-transitory computer-readable medium described herein, the collision handling rule defines the action as an error condition when a communication type of the uplink transmission may be a dedicated-RRC-configured uplink transmission and defines the action as based on implementation of the network entity when the communication type may be a non-dedicated-RRC-configured uplink transmission and the collision handling rule for the type 1A CSS set and a type 1 CSS set collision handling rule may be defined separately.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the SS set may be a type OB CSS set, the PDCCH monitoring may be for monitoring for a multicast and broadcast services (MBS) broadcast transmission, and the type OB CSS set may be different from a type 0 CSS set.

In some examples of the method, network entities, and non-transitory computer-readable medium described herein, the collision handling rule defines the action as an error condition when a communication type of the uplink transmission may be a dedicated-RRC-configured uplink transmission and defines the action as based on implementation of the network entity when the communication type may be a non-dedicated-RRC-configured uplink transmission, the collision handling rule may be independent from the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as performing the uplink transmission when a communication type of the uplink transmission may be a dedicated-RRC-configured uplink transmission, the collision handling rule may be independent from the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as an error condition when a communication type of the uplink transmission may be a dedicated-RRC-configured uplink transmission and when the PDCCH monitoring includes a control channel of the MBS transmission and defines the action as based on implementation of the network entity when the communication type may be the dedicated-RRC-configured uplink transmission and when the PDCCH monitoring includes a transport channel of the MBS transmission and the collision handling rule for the type OB CSS set and a type 0 CSS set collision handling rule may be defined jointly.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as based on implementation of the network entity when a communication type of the uplink transmission may be a non-dedicated-RRC-configured uplink transmission, the collision handling rule may be independent of the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the collision handling rule defines the action as based on implementation of the network entity when a communication type of the uplink transmission may be a dedicated-RRC-configured uplink transmission, the collision handling rule may be independent of the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as an error condition when a communication type of the uplink transmission may be a dedicated-RRC-configured uplink transmission and when the PDCCH monitoring includes a transport channel of the MBS transmission and defines the action as based on implementation of the network entity when the communication type may be the dedicated-RRC-configured uplink transmission and when the PDCCH monitoring includes a control channel of the MBS transmission and the collision handling rule for the type OB CSS set and a type 0 CSS set collision handling rule may be defined jointly.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the SS set may be a type OB CSS set, the PDCCH monitoring may be for monitoring an MBS multicast transmission, and the collision handling rule for the type OB CSS set may be different from a type 0 CSS set collision handling rule.

In some examples of the method, network entities, and non-transitory computer-readable medium described herein, the collision handling rule defines the action as an error condition when a communication type of the uplink transmission may be a dedicated-RRC-configured uplink transmission and defines the action as based on implementation of the network entity when the communication type may be a non-dedicated-RRC-configured uplink transmission, the collision handling rule may be independent from the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as performing the uplink transmission when a communication type of the uplink transmission may be a dedicated-RRC-configured uplink transmission, the collision handling rule may be independent from the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as an error condition when a communication type of the uplink transmission may be a dedicated-RRC-configured uplink transmission and when the PDCCH monitoring includes a control channel of the MBS transmission and defines the action as based on implementation of the network entity when the communication type may be the dedicated-RRC-configured uplink transmission and when the PDCCH monitoring includes a transport channel of the MBS transmission and the collision handling rule for the type OB CSS set and a type 0 CSS set collision handling rule may be defined jointly.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as based on implementation of the network entity when a communication type of the uplink transmission may be a non-dedicated-RRC-configured uplink transmission, the collision handling rule may be independent of the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent of the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as an error condition when a communication type of the uplink transmission may be a dedicated-RRC-configured uplink transmission and when the PDCCH monitoring includes a transport channel of the MBS transmission and defines the action as based on implementation of the network entity when the communication type may be the dedicated-RRC-configured uplink transmission and when the PDCCH monitoring includes a control channel of the MBS transmission and the collision handling rule for the type OB CSS set and a type 0 CSS set collision handling rule may be defined jointly.

In some examples of the method, network entities, and non-transitory computer-readable medium described herein, the error condition may be an assumption regarding non-occurrence of a collision between the PDCCH monitoring in the SS set and the uplink transmission.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined separately.

In some examples of the method, network entities, and non-transitory computer-readable medium described herein, the collision handling rule defines the action as based on implementation of the network entity, the collision handling rule may be independent from a communication type of the uplink transmission, the collision handling rule may be independent from the PDCCH monitoring including a transport channel or a control channel of the MBS transmission, and the collision handling rule for the type OB CSS set and a type 0 CSS set collision handling rule may be defined jointly.

In some examples of the method, network entities, and non-transitory computer-readable medium described herein, the network entity may be a UE.

In some examples of the method, network entities, and non-transitory computer-readable medium described herein, the collision condition may be a potential collision condition.

In some examples of the method, network entities, and non-transitory computer-readable medium described herein, the collision condition may be an actual collision condition.

In some examples of the method, network entities, and non-transitory computer-readable medium described herein, the collision condition exists between the SS set for the PDCCH monitoring and the uplink transmission based on a temporal overlap between the SS set for the PDCCH monitoring and the uplink transmission.

In some examples of the method, network entities, and non-transitory computer-readable medium described herein, the SS set for the PDCCH monitoring may be within a first time period and the uplink transmission may be scheduled to occur during a second time period and the collision condition exists between the SS set for the PDCCH monitoring and the uplink transmission based on an overlap of the first time period and the second time period.

In some examples of the method, network entities, and non-transitory computer-readable medium described herein, operations in the half-duplex mode may be associated with frequency division multiplexing (FDD) operations and the PDCCH monitoring of the SS set and the uplink transmission may be in a paired spectrum.

In some examples of the method, network entities, and non-transitory computer-readable medium described herein, the action may be only performing the uplink transmission based on occurrence of the collision condition.

In some examples of the method, network entities, and non-transitory computer-readable medium described herein, the action may be only performing the PDCCH monitoring in the SS set.

In some examples of the method, network entities, and non-transitory computer-readable medium described herein, the collision condition may be an actual collision condition and the network entity selects whether to perform the uplink transmission or to perform the PDCCH monitoring in the SS set.

### BRIEF DESCRIPTION OF THE DRAWINGS

FIG. 1 shows an example of a wireless communications system that supports search space (SS) monitoring for a half-duplex user equipment (UE) in accordance with one or more aspects of the present disclosure.

FIG. 2 shows an example of a wireless communications system that supports SS monitoring for a half-duplex UE in accordance with one or more aspects of the present disclosure.

FIG. 3 shows an example of a collision condition that supports SS monitoring for a half-duplex UE in accordance with one or more aspects of the present disclosure.

FIG. 4 shows an example of a method that supports SS monitoring for a half-duplex UE in accordance with one or more aspects of the present disclosure.

FIGS. 5 and 6 show block diagrams of devices that support SS monitoring for a half-duplex UE in accordance with one or more aspects of the present disclosure.

FIG. 7 shows a diagram of a system including a device that supports SS monitoring for a half-duplex UE in accordance with one or more aspects of the present disclosure.

FIG. 8 shows a flowchart illustrating methods that support SS monitoring for a half-duplex UE in accordance with one or more aspects of the present disclosure.

### DETAILED DESCRIPTION

Wireless networks may include a half-duplex network entity (e.g., a user equipment (UE) operating in a half-duplex mode) that is able to either perform an uplink transmission or monitor for/receive a downlink transmission, but not both, at the same time. For example, the network entity may have one transmit/receive chain available for wireless communications at any given time period. The network may define some rules to be applied by the network entity when a collision occurs (e.g., in the time domain), such as when a downlink transmission and an uplink transmission are to occur during the same or partially overlapping time period. However, collision handling rules between certain downlink transmissions (e.g., downlink transmissions over a certain type of control channel) and uplink transmissions are not provided in such networks.

Accordingly, the described techniques provide for collision handling rules to be applied by the half-duplex network entity (e.g., the UE operating in a half-duplex mode) during a collision condition. For example, the network entity may receive or otherwise obtain information that configures the network entity for physical downlink control channel (PDCCH) monitoring in a search space (SS) set. The network entity may receive or otherwise obtain control information that indicates an uplink transmission. However, a collision condition may exist between the PDCCH monitoring in the SS set and the uplink transmission. This may include the PDCCH monitoring in the SS set and the uplink transmission overlapping, partially or fully, in the time domain. For example, a collision condition may exist between the PDCCH monitoring in the SS set in a set of symbols and the uplink transmission in the set of symbols. The network entity may apply a collision handling rule to perform an action while operating in the half-duplex mode and based on the collision condition. For example, the collision handling rule may result in the network entity adopting or otherwise applying a network entity-based implementation or solution, or the network entity may assume that the collision condition is an error condition, or the network entity may take some other action. For example, the network entity may perform the PDCCH monitoring in the SS set or may perform the uplink transmission. In some aspects, the collision handling rule may be based on the type of SS set in which the PDCCH monitoring is to be performed (e.g., may provide a collision handling rule applicable for a specific type of SS set being configured for the network entity). Accordingly, the network entity may resolve the collision condition according to the collision handling rule.

Aspects of the disclosure are initially described in the context of wireless communications systems. Aspects of the disclosure are further illustrated by and described with reference to apparatus diagrams, system diagrams, and flowcharts that relate to SS monitoring for half-duplex UE.

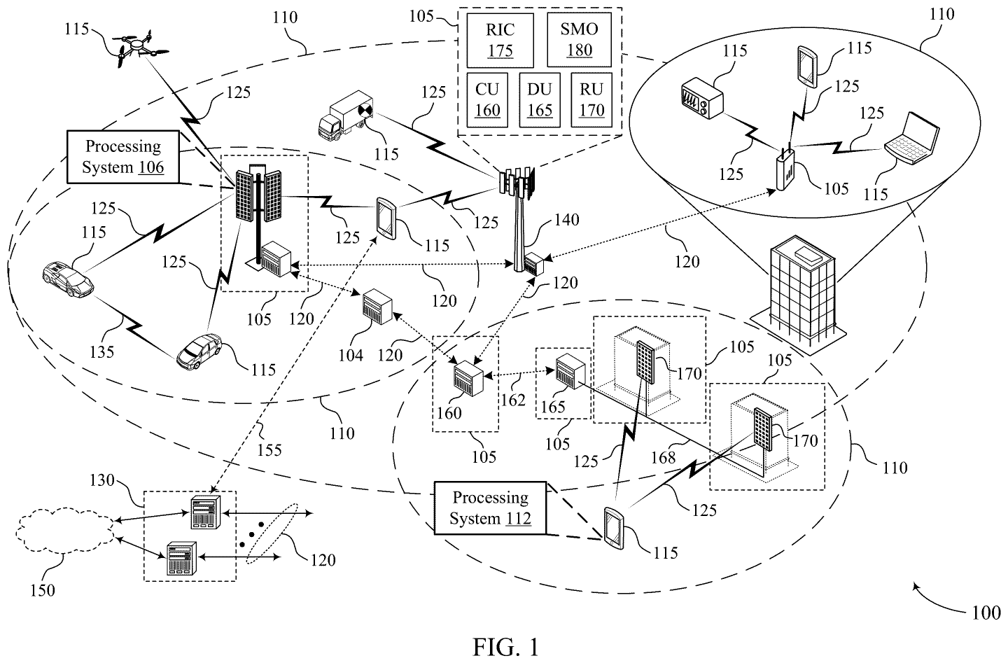

FIG. 1 shows an example of a wireless communications system 100 that supports SS monitoring for half-duplex UE in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support SS monitoring for half-duplex UE as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more SS sets, and each SS set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information (e.g., DCI) format having a given payload size. SS sets may include common SS (CSS) sets configured for sending control information to multiple UEs 115 and UE-specific (USS) SS sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A network entity (e.g., a UE 115) may receive information that configures PDCCH monitoring in a SS set. The network entity may receive control information that indicates an uplink transmission, wherein a collision condition exists between the PDCCH monitoring in the SS set and the uplink transmission. The network entity may perform, during operation in a half-duplex mode, an action in accordance with a collision handling rule, wherein the collision handling rule is based on the collision condition and the search space set.

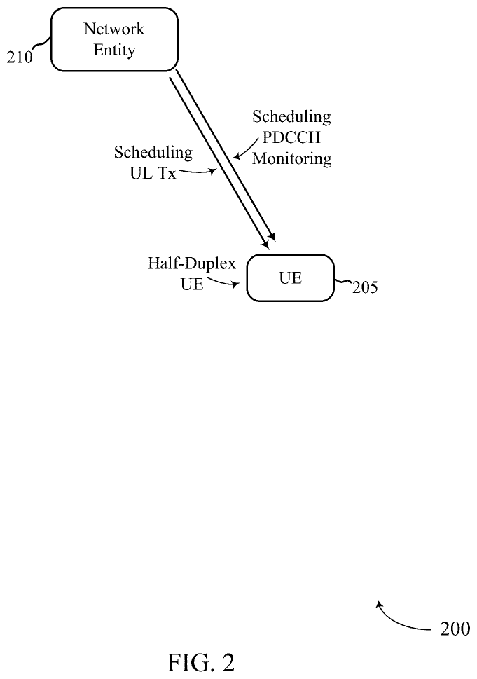

FIG. 2 shows an example of a wireless communications system 200 that supports SS monitoring for half-duplex UE in accordance with one or more aspects of the present disclosure. Wireless communications system 200 may implement aspects of wireless communications system 100. Wireless communications system 200 may include a UE 205 and a network entity 210, which may be examples of the corresponding devices described herein. For example, the UE 205 may be an example of a network entity operating in a half-duplex mode and the network entity 210 may be an example of a base station, gNB, or other network component of the radio access network (RAN) wirelessly communicating with the UE 205.

In some examples, the network entity (e.g., the UE 205) may be a non-limiting example of a reduced capability device. This may include the network entity operating in a half-duplex mode where the network entity is not capable of simultaneous transmissions and receptions on a serving cell. For example, the network entity may be treated, considered, or otherwise associated with a paired spectrum where the network entity operates in a FDD mode. That is, the network may consider (such as during scheduling or other operations) the network entity as a paired spectrum device in that the downlink channel frequency resources and the uplink channel frequency resources associated with the network entity are considered the paired spectrum. Such operations may reduce the complexity of the UE 205, which may support wireless sensor operations, video surveillance operations, or similar operations.

Broadly, the network entity (e.g., the UE 205) operating in the half-duplex mode may create a situation where a conflict or collision may occur between a downlink transmission to the network entity and an uplink transmission from the network entity. That is, in some scenarios the network entity may be scheduled (e.g., by the network entity 210) to perform an uplink transmission to the network entity 210 while, during the same or partially overlapping time period, also being configured to monitor for a downlink transmission (e.g., from the network entity 210). During operations in the half-duplex mode the network entity may not be able to simultaneously perform the uplink transmission and to perform the uplink transmission.

Accordingly, some aspects may include various collision handling rules being configured or otherwise signaled to the network entity that may generally define the action the network entity is to perform when a temporal collision occurs. Such collision handling rules are generally defined in terms of the nature or type of colliding downlink transmissions and uplink transmissions. For example, different types of SS sets may be configured for the network entity for PDCCH monitoring, which may, in some scenarios, collide in the time domain with an uplink transmission. Examples of the downlink transmissions for the configured SS sets may include cell-specific downlink including a PDCCH monitoring in type-0/0A/1/2 CSS sets.

In some wireless networks, the collision handling rule for responding to such collisions may depend on the type of uplink transmission that collides with the PDCCH monitoring in the SS set. One example of a communication type for the uplink transmissions may include, but is not limited to, dedicated-RRC-configured uplink transmissions. The dedicated-RRC-configured uplink transmissions may include a configured grant (CG)-based physical uplink shared channel (PUSCH) uplink transmission, a physical random-access channel (PRACH) uplink transmission and msgA for contention free random-access (CFRA), a sounding reference signal (SRS) uplink transmission, or a physical uplink control channel (PUCCH) uplink transmission.

However, there may be other communication types scheduled uplink transmissions by the network entity that are non-dedicated-RRC-configured. For example, non-dedicated-RRC-configured communication types may include dynamically scheduled uplink transmissions, such as a PUCCH (including HARQ feedback for msg4/msgB) uplink transmission, a dynamic grant PUSCH (including msg3) uplink transmission, an aperiodic SRS uplink transmission, or a PDCCH-ordered PRACH. Other examples of non-dedicated-RRC-configured uplink transmissions may include cell-specific uplink transmissions, such as a valid PRACH occasion (e.g., msg1 or msgA preamble) uplink transmission or a valid msgA PUSCH occasion, which may be configured by cell-specific RRC signaling, such as in system information block (SIB) signaling.

Some wireless networks may define collision handling rules for such collision conditions based on the type of the uplink transmission (e.g., dedicated-RRC-configured or non-dedicated-RRC-configured) and the downlink transmission (e.g., PDCCH monitoring in a particular type of SS sets). However, wireless communications system 200 may include or otherwise support different types of SS sets being configured for the network entity (e.g., USS or a type-3 CSS) that do not have corresponding collision handling rules. This may result, when a collision condition occurs, in a disconnect between the network and the network entity regarding how to resolve the collision condition (e.g., which action to be taken). This approach may lead to disruption of wireless communications between the network entity and the network (e.g., between the UE 205 and the network entity 210).

Accordingly, aspects of the described techniques identify or otherwise configure collision handling rules to be applied when selecting an action for the network entity and the network to take when a collision condition occurs. The collision handling rules described herein may include the network entity being configured for PDCCH monitoring in a SS set and being scheduled for an uplink transmission. The collision handline rules discussed herein may be based on the occurrence of the collision condition as well as the communication type of uplink transmission that is colliding with the PDCCH monitoring in the SS set.

For example, the network entity may receive or otherwise obtain information that configures PDCCH monitoring in a SS set. The information may be received or obtained from the network (e.g., the network entity 210). The information may generally define or otherwise identify the resources (e.g., the frequency resources, the time resources, the spatial resources, or the code resources) that the network entity is to monitor to receive the PDCCH (e.g., the downlink transmission) from the network. Based on the network entity operating in the half-duplex mode, the network entity may perform an action in accordance with the collision handling rules discussed herein. The collision handling rule may be based on the collision condition occurring (e.g., an actual collision condition, a potential collision condition, or both), based on the SS set being monitored, and, in some examples, based on the communication type of the uplink transmission that collides with the PDCCH monitoring in the SS set.

Broadly, application of the collision handling rules may result in different actions by the network entity (and the network). For example, one action may be that the network entity performs the uplink transmission in response to the collision condition. Another example action may be that the network entity may perform the PDCCH monitoring in the SS set in response to the collision condition. Another example action may be that it is up to the network entity how to respond to the collision condition (e.g., the network entity may select to perform the uplink transmission or monitor PDCCH in the SS set). Another example action may be that the collision condition results in an error condition. That is, in some examples the network entity may not expect or assume that the collision condition will occur between the PDCCH monitoring in the SS set and the uplink transmission, where the occurrence may be implemented by network configuration or scheduling. The action to take when the collision condition results in the error condition may be based on network implementation, based on network entity implementation, or both.

A first collision handling rule may be applicable when the SS set that the network entity is to monitor PDCCH is a type 2A common SS (CSS) set. A type 2A CSS set may be configured for the network entity to monitor for a paging early indicator (PEI). That is, the PEI may be supported for power saving operations, where the PDCCH monitoring for PEI may be scheduled in a type2A PDCCH CSS set. The type2A PDCCH CSS set may be configured by a pei-SearchSpace parameter indicated in a pei-ConfigBWP parameter for a DCI format 2_7 with or having a CRC scrambled by a PEI-RNTI on the primary cell of the master cell group (MCG). As discussed above, some wireless networks may define a type 2 CSS set collision handling rule. However, it may be beneficial that a collision handling rule for the type 2A CSS set is different from that of the type 2 CSS set (e.g., since the type 2 and type 2a CSS sets are used for different PDCCH monitoring). The type 2 CSS set may be configured by pagingSearchSpace for a DCI format 1_0 with CRC scrambled by a P-RNTI on the primary cell of the MCG.

Different examples of collision handling rules that may be applicable for actions taken when the type 2A CSS set collide in the time domain with an uplink transmission are provided. One example of such collision handling rules for a collision condition between the PDCCH monitoring in the type 2A CSS set and the uplink transmission is shown in Table 1a below.

TABLE 1a

| Type of PDCCH | Communication Type of | Collision |
|---|---|---|
| monitoring in the SS set | Uplink Transmission | Handling Rule |
| Type 2A PDCCH CSS | Dedicated RRC Uplink | Error Case (Error |
| for pei-SearchSpace | Transmission | Condition) |
| Type 2A PDCCH CSS | Other uplink transmission | Up to UE (as an |
| for pei-SearchSpace | (including dynamic | example of up to |
| | scheduled uplink and/or | network entity |
| | cell-specific uplink) | implementation) |

In this example, the collision handling rule may define the action as an error condition when the communication type of the uplink transmission is a dedicated-RRC-configured uplink transmission that collides with PDCCH monitoring in a type 2A CSS set for PEI. This collision handling rule may define the action as based on implementation of the network entity when the communication type of the uplink transmission is a non-dedicated-RRC-configured uplink transmission (e.g., other uplink transmission types) that collides with PDCCH monitoring in a type 2A CSS set for PEI. That is, the network entity may select whether to perform the uplink transmission or to monitor PDCCH in the type 2A CSS set.

As discussed above, the error condition may be based on an expectation or assumption that the collision between the PDCCH monitoring in the type 2A CSS set and the uplink transmission will not occur. More particularly, as the network generally schedules both the dedicated-RRC-configured uplink transmission and the PDCCH monitoring in the SS set, the network generally avoids scheduling both in a manner that results in the collision condition occurring. Actions to be taken in response to the error condition may be based on implementation of the network entity (e.g., the network entity may select the action to be taken when an error condition occurs), implementation of the network (e.g., signaled to the network entity from the network), or a different action (e.g., declare the error condition or predefined as not expected by the network entity).

Another example of a collision handling rule that may be applied when the collision condition occurs between PDCCH monitoring in a type 2A CSS set and the uplink transmission are shown in Table 1b below.

TABLE 1b

| Type of PDCCH | Communication Type of | Collision |
|---|---|---|
| monitoring in the SS set | Uplink Transmission | Handling Rule |
| Type 2A PDCCH CSS for | Dedicated-RRC | Up to UE |
| pei-SearchSpace | configured uplink or | |
| | Other uplink transmission | |
| | (including dynamic | |
| | scheduled uplink and/or | |
| | cell-specific uplink) | |

In this example, the collision handling rule may define the action as based on implementation of the network entity independent from the communication type of the uplink transmission that collides with the PDCCH monitoring in the type 2A CSS set. That is, this collision handling rule may result in the network entity selecting the action to be taken in response to the collision condition occurrence. This collision handling rule may be independent from the communication type of the colliding uplink transmission. For example, the collision handling rule may be applied for both dedicated-RRC-configured uplink transmissions and other communication types of uplink transmissions (e.g., a non-dedicated-RRC-configured uplink transmission).

Another example of a collision handling rule that may be applied when the collision condition occurs between PDCCH monitoring in a type 2A CSS set and the uplink transmission are shown in Table 1c below.

TABLE 1c

| Type of PDCCH | Communication Type of | Collision |
|---|---|---|
| monitoring in the SS set | Uplink Transmission | Handling Rule |
| Type 2A PDCCH CSS for | Dedicated RRC Uplink | Transmit the |
| pei-SearchSpace | Transmission | Uplink |
| | | Transmission |
| Type 2A PDCCH CSS for | Other uplink transmission | Up to UE |
| pei-SearchSpace | (including dynamic | |
| | scheduled uplink and/or | |
| | cell-specific uplink) | |

In this example, the collision handling rule may define the action as based on implementation of the network entity when the communication type of the uplink transmission is another uplink transmission communication type (e.g., non-dedicated-RRC-configured) that collides with PDCCH monitoring in the type 2A CSS set. This collision handling rule may define the action as the network entity performing the uplink transmission when the communication type of the uplink transmission is dedicated-RRC-configured uplink transmission. This example collision handling rule may provide for the network entity to prioritize the uplink transmission and ignore the PDCCH monitoring in the type 2A CSS set to select an action to resolve or otherwise in view of the collision condition.

Accordingly, non-limiting examples of collision handling rules are illustrated in Table 1 that may be applied during a collision condition between the network entity monitoring PDCCH in a type 2A CSS set and an uplink transmission. Some example collision handling rules are based on the communication type of the uplink transmission or may be independent from the communication type of the uplink transmission.

A second collision handling rule may be applicable when the SS set that the network entity is to monitor PDCCH in is a type 1A CSS set. A type 1A CSS set may be configured for the network entity to monitor for a small data transmission (SDT). That is, the network entity monitoring for sdt-SearchSpace for configured grant SDT (CG-SDT) and random access SDT (RA-SDT) when operating (e.g., in RRC inactive state) may collide in the time domain with the uplink transmission. Although the type 1A CSS set for SDT may be cell-specific configured resources and broadcast in SIB, it may also be used for UE-specific uplink transmissions and shared by more than one UE. As discussed above, some wireless networks may define a type 1 CSS set collision handling rule that is different from the type 1A CSS set. The type 1 CSS set may be configured by ra-SearchSpace for a DCI format with CRC scrambled by a RA-RNTI, a MsgB-RNTI, or a TC-RNTI on the primary cell.

Different examples of collision handling rules that may be applicable for actions taken when the type 1A CSS set collide in the time domain with an uplink transmission are provided. One example of such collision handling rules for a collision condition between the PDCCH monitoring in the type 1A CSS set and the uplink transmission is shown in Table 2a below.

TABLE 2a

| Type of PDCCH | Communication Type of | Collision |
|---|---|---|
| monitoring in the SS set | Uplink Transmission | Handling Rule |
| Type 1/1A PDCCH CSS | Dedicated RRC Uplink | Error Case (Error |
| for sdt-SearchSpace | Transmission | Condition) |
| Type 1/1A PDCCH CSS | Other uplink transmission | Up to UE |
| for sdt-SearchSpace | (including dynamically | |
| | scheduled uplink and/or | |
| | cell-specific uplink) | |

In this example, the collision handling rule may define the action as an error condition when the communication type of the uplink transmission is a dedicated-RRC-configured uplink transmission that collides with the PDCCH monitoring in the type 1A CSS set. This collision handling rule may define the action as based on implementation of the network entity when the communication type of the uplink transmission is a non-dedicated-RRC-configured uplink transmission (e.g., other uplink transmission types). Again, the error condition may be based on an expectation or assumption that the collision between the PDCCH monitoring in the type 1A CSS set and the uplink transmission will not occur.

In some aspects, this example may include the type 1 CSS set and the type 1A CSS set to be defined jointly. That is, the same collision handling rule may be applied when the collision condition exists between the uplink transmission and PDCCH monitoring in the type 1 CSS set as well as the type 1A CSS set.

Another example of a collision handling rule that may be applied when the collision condition occurs between PDCCH monitoring in a type 1A CSS set and the uplink transmission is shown in Table 2b below.

TABLE 2b

| Type of PDCCH | Communication Type of | Collision |
|---|---|---|
| monitoring in the SS set | Uplink Transmission | Handling Rule |
| Type 1 PDCCH CSS for | Dedicated RRC Uplink | Error Case |
| sdt-SearchSpace | Transmission | (Error |
| | | Condition) |
| Type 1 PDCCH CSS for | Other uplink transmission | Up to UE |
| sdt-SearchSpace | | |
| Type 1A PDCCH CSS for | Dedicated RRC or Other | Up to UE |
| sdt-SearchSpace | Uplink Transmission | |

In this example, the collision handling rule may define the action as based on implementation of the network entity. This collision handling rule may result in the network entity selecting the action to be taken in response to occurrence of the collision condition. This collision handling rule may be independent from the communication type of the uplink transmission that collides with the PDCCH monitoring in the type 1A CSS set. That is, this collision handling rule may be applied for both a dedicated-RRC-configured uplink transmission and other communication types of uplink transmissions (e.g., a non-dedicated-RRC-configured uplink transmission).

In this example, the collision handling rule for the type 1 CSS set and the type 1A CSS set may be defined separately. That is, different collision handing rules may be defined and applied depending on whether the PDCCH monitoring in the SS set is in a type 1 CSS set or in a type 1A CSS set that collide with the uplink transmission.

Another example of a collision handling rule that may be applied when the collision condition occurs between PDCCH monitoring in a type 1A CSS set and the uplink transmission are shown in Table 2c below.

TABLE 2c

| Type of PDCCH | Communication Type of | Collision |
|---|---|---|
| monitoring in the SS set | Uplink Transmission | Handling Rule |
| Type 1/1A PDCCH CSS | Dedicated RRC or Other | Up to UE |
| for sdt-SearchSpace | Uplink Transmission | |

In this example, the collision handling rule may define the action as based on implementation of the network entity. This collision handling rule may result in the network entity selecting the action to be taken in response to the collision condition occurrence. This collision handling rule may be independent from the communication type of the uplink transmission that collides with PDCCH monitoring in the type 1A CSS set. That is, this collision handling rule may be applied for both a dedicated-RRC-configured uplink transmission and other communication types of uplink transmissions (e.g., a non-dedicated-RRC-configured uplink transmission). In this example, the collision handling rules for the type 1 CSS set and the type 1A CSS set may be defined jointly. That is, the same collision handing rule may be defined and applied when the PDCCH monitoring in the SS set is in either the type 1 CSS set or in the type 1A CSS set.

Another example of a collision handling rule that may be applied when the collision condition occurs between PDCCH monitoring in a type 1A CSS set and the uplink transmission are shown in Table 2d below.

TABLE 2d

| | Communication | |
|---|---|---|
| Type of PDCCH monitoring | Type of Uplink | Collision |
| in the SS set | Transmission | Handling Rule |
| Type 1 PDCCH CSS for | Dedicated RRC Uplink | Error Case (Error |
| sdt-SearchSpace | Transmission | Condition) |
| Type 1 PDCCH CSS for | Other Uplink | Up to UE |
| sdt-SearchSpace | Transmission | |
| Type 1A PDCCH CSS for | Dedicated RRC | Error Case (Error |
| sdt-SearchSpace | | Condition) |
| Type 1A PDCCH CSS for | Other Uplink | Up to UE |
| sdt-SearchSpace | Transmission | |

In this example, the collision handling rule may define the action as an error condition when the communication type of the uplink transmission is a dedicated-RRC-configured uplink transmission that collides with PDCCH monitoring in a type 1A CSS set for SDT. The collision handling rule may define the action as based on implementation of the network entity when the communication type of the uplink transmission is other communication types (e.g., non-dedicated RRC uplink transmissions). This collision handling rule may result in the network entity selecting the action to be taken in response to the collision condition occurrence. In this example, the collision handling rules for the type 1 CSS set and the type 1A CSS set may be defined separately. That is, different collision handing rules may be defined and applied depending on whether the PDCCH monitoring in the SS set is in a type 1 CSS set or in a type 1A CSS set.

A third collision handling rule may be applicable when the SS set that the network entity is to monitor PDCCH in is a type OB CSS set. A type OB CSS set may be configured for the network entity to monitor for a MBS broadcast. That is, the MBS broadcast may include or otherwise be associated with a control channel (multicast control channel (MCCH)) and a transport channel (multicast transport channel (MTCH)). The network entity monitoring for SearchSpaceMCCH/SearchSpaceMTCH for MBS broadcast may collide in the time domain with the uplink transmission. It may be beneficial to define a type 0 CSS set collision handling rule that is different from the type OB CSS set. The type 0 CSS may be configured for pdcch-ConfigSIB1 in MIB, by searchSpaceSIB1, by searchSpaceZero for a DCI format with CRC scrambled by a SI-RNTI, searchSpaceZero by providing searchSpaceID=0 for searchSpaceMCCH or searchSpaceMTCH for a DCI format 4_0 with CRC scrambled by a MCCH-RNTI or a G-RNTI for MBS broadcast on the primary cell of the MCG.

Different examples of collision handling rules that may be applicable for actions taken when PDCCH monitoring in the type OB CSS set collide in the time domain with an uplink transmission are provided. It may be beneficial to provide such collision handling rules for PDCCH monitoring in a type OB CSS set for the UE to follow. One example of such collision handling rules for a collision condition between the PDCCH monitoring in the type OB CSS set and the uplink transmission is shown in Table 3a below.

TABLE 3a

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC | Error Case (Error |
| searchSpaceMCCH/ | Uplink Transmission | Condition) |
| searchSpaceMTCH | | |
| Type 0/0B PDCCH CSS for | Other uplink | Up to UE |
| searchSpaceMCCH/ | transmission | |
| searchSpaceMTCH | (including cell- | |
| | specific uplink) | |

In this example, the collision handling rule may define the action as an error condition when the communication type of the uplink transmission is a dedicated-RRC-configured uplink transmission that collides with the PDCCH monitoring in the type OB CSS set. This collision handling rule may define the action as based on implementation of the network entity when the communication type of the uplink transmission is a non-dedicated-RRC-configured uplink transmission (e.g., other uplink transmission types). Again, the error condition may be based on an expectation or assumption that the collision between the PDCCH monitoring in the type OB CSS set and the uplink transmission will not occur.

In some aspects, this example may include the type 0 CSS set and the type OB CSS set at least for monitoring one of searchSpaceMCCH and searchSpaceMTCH to be defined jointly. That is, the same collision handling rule may be applied when the collision condition exists between the uplink transmission and PDCCH monitoring in the type 0 CSS set as well as the type OB CSS set.

In some aspects, this example may be independent of whether the PDCCH monitoring includes the transport channel (MTCH) or the control channel (MCCH) of the MBS broadcast transmission. That is, the same collision handling rule may be applied when the collision condition exists between the uplink transmission and PDCCH monitoring in the transport channel or in the control channel in the type OB CSS set.

In some aspects of the examples shown in Table 3a for MBS broadcast, the collision handling rule may be specified in the field cfr-ConfigMCCH-MTCH (configured in SIB) and may be configured for PDCCH and PDSCH receptions providing broadcast MCCH/MTCH for UEs in all states. For example, a UE may be configured by cfr-ConfigMCCH-MTCH with an MBS frequency resource for PDCCH and PDSCH receptions providing MCCH and broadcast MTCH. Otherwise, the MBS frequency resource may be the same as for the CORESET with index 0 that is associated with a Type0-PDCCH CSS set for PDCCH and PDSCH receptions providing MCCH and broadcast MTCH. A UE may monitor PDCCH for scheduling PDSCH receptions for broadcast MCCH or broadcast MTCH. For a UE operating in an RRC connected state, the UE may monitor searchSpaceMCCH/searchSpaceMTCH if the active downlink BWP fully confines the cfr-ConfigMCCH-MTCH with the same subcarrier spacing/cyclic prefix (SCS/CP).

In some examples, if the active downlink BWP and an MBS frequency resource provided by cfr-ConfigMCCH-MTCH or determined by the CORESET with index 0 when cfr-ConfigMCCH-MTCH is not provided for a UE have the same SCS and same CP length and the active downlink BWP includes all resource blocks of the MBS frequency resource, and if the UE is provided with searchSpaceMCCH or searchSpaceMTCH for Type0B-PDCCH CSS set on the primary cell or for Type3-PDCCH CSS set on a secondary cell, the UE may monitor PDCCH for detection of broadcast DCI formats (e.g., in DCI format 4_0) on the active DL BWP.

Therefore, for half-duplex-FDD Reduced capability UEs the collision between the MBS broadcast PDCCH and the dedicated-RRC-configured uplink may be specified as being avoided in the case that UE monitors the searchSpaceMCCH/searchSpaceMTCH for a Type-0B-CSS in the active downlink BWP. This may confine the cfr-ConfigMCCH-MTCH to have the same SCS/CP. Thus, there may be no need to avoid the collision condition. That is, a half-duplex UE does not expect to receive both a Type-0/0A/1/2-PDCCH CSS set configuration for PDCCH reception in a set of symbols and dedicated higher layer parameters configuring transmission in the set of symbols. A half-duplex UE does not expect to receive both a Type-0B CSS set configuration for PDCCH reception in searchSpaceMCCH or searchSpaceMTCH in a set of symbols and dedicated higher layer parameters configuration transmission in the set of symbols at least when the active downlink BWP and an MBS frequency resource provided by cfr-ConfigMCCH-MTCH or determined by CORESET with index 0 when cfr-ConfigMCCH-MTCH is not provided for the UE have the same SCS and the same CP length and the active downlink BWP includes all resource blocks of the MBS frequency resource.

Another example of such collision handling rules for a collision condition between the PDCCH monitoring in the type OB CSS set and the uplink transmission is shown in Table 3b below.

TABLE 3b

| | Communication | |
|---|---|---|
| Type of PDCCH monitoring | Type of Uplink | Collision |
| in the SS set | Transmission | Handling Rule |
| Type 0 PDCCH CSS for | Dedicated RRC | Error Case (Error |
| searchSpaceMCCH/ | Uplink Transmission | Condition) |
| searchSpaceMTCH | | |
| Type 0B PDCCH CSS for | Dedicated RRC | Up to UE (or |
| searchSpaceMCCH/ | Uplink Transmission | Transmit Uplink) |
| searchSpaceMTCH | | |
| Type 0/0B PDCCH CSS for | Other uplink | Up to UE |
| searchSpaceMCCH/ | transmission | |
| searchSpaceMTCH | | |

In this example, the collision handling rule may define the action as based on implementation of the network entity. The collision handling rule in this example may be independent from the communication type of the uplink transmission (e.g., for both dedicated-RRC-configured and non-dedicated-RRC-configured uplink transmissions) that collides with PDCCH monitoring in the type OB CSS set. The collision handling rule in this example may be independent of whether the PDCCH monitoring is in the transport channel (MTCH) or the control channel (MCCH) for the MBS broadcast transmission. In this example, the type 0 CSS set and the type OB CSS set are to be defined separately. That is, the different collision handling rules may be applied when the collision condition exists between the uplink transmission and PDCCH monitoring in the type 0 CSS set or the type OB CSS set.

In another collision handling rule shown in Table 3b, the collision handling rule may define the action as the network entity performing the uplink transmission when the communication type of the uplink transmission is the dedicated-RRC-configured uplink transmission. This example may include the condition handling rule being independent from whether the network entity is monitoring PDCCH in the transport channel or the control channel. In this example, the type 0 CSS set and the type OB CSS set are to be defined separately. That is, the different collision handling rules may be applied when the collision condition exists between the uplink transmission and PDCCH monitoring in the type 0 CSS set or the type OB CSS set.

Another example of such collision handling rules for a collision condition between the PDCCH monitoring in the type OB CSS set and the uplink transmission is shown in Table 3c below.

TABLE 3c

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC | Error Case (Error |
| searchSpaceMCCH | Uplink Transmission | Condition) |
| Type 0/0B PDCCH CSS for | Dedicated RRC | Up to UE (or |
| searchSpaceMTCH | Uplink Transmission | Transmit Uplink) |
| Type 0/0B PDCCH CSS for | Other uplink | Up to UE |
| searchSpaceMCCH/ | transmission | |
| searchSpaceMTCH | (including cell- | |
| | specific uplink) | |

In this example, the collision handling rule may define the action as an error condition when the communication type of the uplink transmission is dedicated-RRC-configured and when the PDCCH monitoring includes the control channel (MCCH) of the MBS broadcast transmission. The collision handling rule may define the action as based on implementation of the network entity when the communication type of the uplink transmission is dedicated-RRC-configured and when the PDCCH monitoring includes the transport channel (MTCH) of the MBS broadcast transmission. Alternatively, the collision handling rule may define the action as the network entity performing the uplink transmission when the communication type of the uplink transmission is dedicated-RRC-configured and when the PDCCH monitoring includes the transport channel (MTCH) of the MBS broadcast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

In another collision handling rule shown in Table 3c, the collision handling rule may define the action as based on implementation of the network entity when the communication type of the uplink transmission is a non-dedicated-RRC-configured uplink transmission (e.g., other uplink transmission types). This example may be independent from whether the PDCCH monitoring includes the transport channel (MTCH) or the control channel (MCCH) of the MBS broadcast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

Another example of such collision handling rules for a collision condition between the PDCCH monitoring in the type OB CSS set and the uplink transmission is shown in Table 3d below.

TABLE 3d

| | Communication | |
|---|---|---|
| Type of PDCCH monitoring | Type of Uplink | Collision |
| in the SS set | Transmission | Handling Rule |
| Type 0 PDCCH CSS for | Dedicated RRC | Error Case (Error |
| searchSpaceMCCH | Uplink Transmission | Condition) |
| Type 0B PDCCH CSS for | Dedicated RRC | Up to UE (or |
| searchSpaceMCCH or | Uplink Transmission | Transmit Uplink) |
| Type 0/0B CSS for | | |
| searchSpaceMTCH | | |
| Type 0/0B PDCCH CSS for | Other uplink | Up to UE |
| searchSpaceMCCH/ | transmission | |
| searchSpaceMTCH | | |

In this example, the collision handling rule may define the action as based on implementation of the network entity when the communication type of the uplink transmission is dedicated-RRC-configured. This example may be independent of whether the PDCCH monitoring is in the transport channel or in the control channel of the MBS broadcast transmission. In this example, the type 0 CSS set and the type OB CSS set are to be defined separately. That is, different collision handling rules may be applied when the collision condition exists between the uplink transmission and PDCCH monitoring in the type 0 CSS set and in the type OB CSS set. Alternatively, the collision handling rule may define the action as the network entity performing the uplink transmission when the communication type of the uplink transmission is dedicated-RRC-configured and when the PDCCH monitoring includes the control channel (MCCH) or the transport channel (MTCH) of the MBS broadcast transmission. In this example, the type 0 CSS set and the type OB CSS set are to be defined separately.

In another collision handling rule shown in Table 3d, the collision handling rule may define the action as based on implementation of the network entity when the communication type of the uplink transmission is non-dedicated-RRC-configured. This example may be independent from whether the PDCCH monitoring includes the transport channel (MTCH) or the control channel (MCCH) of the MBS broadcast transmission. In this example, the type 0 CSS set and the type OB CSS set are to be defined jointly. That is, the same collision handling rules may be applied when the collision condition exists between the uplink transmission and PDCCH monitoring of MCCH/MTCH in the type 0 CSS set and in the type OB CSS set.

Another example of such collision handling rules for a collision condition between the PDCCH monitoring in the type OB CSS set and the uplink transmission is shown in Table 3e below.

TABLE 3e

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC | Error Case (Error |
| searchSpaceMTCH | Uplink Transmission | Condition) |
| Type 0/0B PDCCH CSS for | Dedicated RRC | Up to UE (or |
| searchSpaceMCCH | Uplink Transmission | Transmit Uplink) |
| Type 0/0B PDCCH CSS for | Other uplink | Up to UE |
| searchSpaceMCCH or | transmission | |
| searchSpaceMTCH | (including cell- | |
| | specific uplink) | |

In this example, the collision handling rule may define the action as an error condition when the communication type of the uplink transmission is dedicated-RRC-configured and when the PDCCH monitoring includes the transport channel (MTCH) of the MBS broadcast transmission. The collision handling rule may define the action as based on implementation of the network entity when the communication type of the uplink transmission is dedicated-RRC-configured and when the PDCCH monitoring includes the control channel (MCCH) of the MBS broadcast transmission.

Alternatively, the collision handling rule may define the action as the network entity performing the uplink transmission when the communication type of the uplink transmission is dedicated-RRC-configured and when the PDCCH monitoring includes the control channel (MCCH) of the MBS broadcast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

In another collision handling rule shown in Table 3e, the collision handling rule may define the action as based on implementation of the network entity when the communication type of the uplink transmission is non-dedicated-RRC-configured. This example may be independent from whether the PDCCH monitoring includes the transport channel (MTCH) or the control channel (MCCH) of the MBS broadcast transmission. In this example, the type 0 CSS set and the type OB CSS set may again be defined jointly. That is, the same collision handling rules may be applied when the collision condition exists between the uplink transmission and PDCCH monitoring of MCCH/MTCH in the type 0 CSS set and in the type OB CSS set.

Another example of such collision handling rules for a collision condition between the PDCCH monitoring in the type OB CSS set and the uplink transmission is shown in Table 3f below.

TABLE 3f

| | Communication | |
|---|---|---|
| Type of PDCCH monitoring | Type of Uplink | Collision |
| in the SS set | Transmission | Handling Rule |
| Type 0 PDCCH CSS for | Dedicated RRC | Error Case (Error |
| searchSpaceMTCH | Uplink Transmission | Condition) |
| Type 0B PDCCH CSS for | Dedicated RRC | Up to UE (or |
| searchSpaceMTCH or | Uplink Transmission | Transmit Uplink) |
| Type 0/0B PDCCH CSS for | | |
| searchSpaceMCCH | | |
| Type 0/0B PDCCH CSS for | Other uplink | Up to UE |
| searchSpaceMCCH/ | transmission | |
| searchSpaceMTCH | | |

In this example, the collision handling rule may define the action as based on implementation of the network entity (e.g., the network entity may perform the uplink transmission). This example may be independent of the communication type of the uplink transmission (e.g., for both dedicated-RRC-configured and non-dedicated-RRC-configured uplink transmissions). This example may be independent of whether the PDCCH monitoring includes the control channel (MCCH) or the transport channel (MTCH) of the MBS broadcast transmission. In this example, the type 0 CSS set and the type OB CSS set are to be defined separately. For example, the type 0 CSS set and the type OB CSS set may be defined separately when the PDCCH monitoring includes the transport channel (MTCH) or may be defined jointly when the PDCCH monitoring includes the control channel (MCCH). That is, different collision handling rules may be applied when the collision condition exists between the uplink transmission and PDCCH monitoring in the type 0 CSS set and in the type OB CSS set.

Another example of such collision handling rules for a collision condition between the PDCCH monitoring in the type OB CSS set and the uplink transmission is shown in Table 3g below.

TABLE 3g

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC or | Up to UE |
| searchSpaceMCCH/ | Other uplink | |
| searchSpaceMTCH | transmission | |

In this example, the collision handling rule may define the action as based on implementation of the network entity. This example may be independent of the communication type of the uplink transmission (e.g., for both dedicated-RRC-configured and non-dedicated-RRC-configured uplink transmissions). This example may be independent of whether the PDCCH monitoring includes the control channel (MCCH) or the transport channel (MTCH) of the MBS broadcast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

A fourth collision handling rule may be applicable when the SS set that the network entity is to monitor PDCCH in is a type OB CSS set. A type OB CSS set may be configured for the network entity to monitor for an MBS multicast. The network entity may be operating in the RRC inactive state in this example. That is, the MBS multicast may include or otherwise be associated with a control channel (MCCH) and a transport channel (MTCH). The network entity monitoring for SearchSpaceMCCH/SearchSpaceMTCH for MBS multicast may collide in the time domain with the uplink transmission. Some wireless networks may define a type 0 CSS set collision handling rule that is different from the type OB CSS set.

Different examples of collision handling rules that may be applicable for actions taken when PDCCH monitoring in the type OB CSS set for MBS multicast transmission collide in the time domain with an uplink transmission are provided. One example of such collision handling rules for a collision condition between the PDCCH monitoring in the type OB CSS set and the uplink transmission is shown in Table 4a below.

TABLE 4a

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC | Error Case (Error |
| searchSpaceMulticastMCCH/ | Uplink Transmission | Condition) |
| searchSpaceMulticastMTCH | | |
| Type 0/0B PDCCH CSS for | Other uplink | Up to UE |
| searchSpaceMCCH-Multicast/ | transmission | |
| searchSpaceMTCH-Multicast | | |

In this example, the collision handling rule may define the action as an error condition when the communication type of the uplink transmission is a dedicated-RRC-configured uplink transmission that collides with the PDCCH monitoring in the type OB CSS set. This collision handling rule may define the action as based on implementation of the network entity when the communication type of the uplink transmission is a non-dedicated-RRC-configured uplink transmission (e.g., other uplink transmission types). Again, the error condition may be based on an expectation or assumption that the collision between the PDCCH monitoring in the type OB CSS set and the uplink transmission will not occur.

In some aspects, this example may include the type 0 CSS set and the type OB CSS set to be defined jointly. That is, the same collision handling rule may be applied when the collision condition exists between the uplink transmission and PDCCH monitoring in the type 0 CSS set as well as the type OB CSS set.

In some aspects, this example may be independent of whether the PDCCH monitoring includes the transport channel (MTCH) or the control channel (MCCH) of the MBS multicast transmission. That is, the same collision handling rule may be applied when the collision condition exists between the uplink transmission and PDCCH monitoring in the transport channel or in the control channel in the type OB CSS set.

In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

Another example of such collision handling rules for a collision condition between the PDCCH monitoring in the type OB CSS set and the uplink transmission is shown in Table 4b below.

TABLE 4b

| | Communication | |
|---|---|---|
| Type of PDCCH monitoring | Type of Uplink | Collision |
| in the SS set | Transmission | Handling Rule |
| Type 0 PDCCH CSS for | Dedicated RRC | Error Case (Error |
| searchSpaceMulticastMCCH/ | Uplink Transmission | Condition) |
| searchSpaceMulticastMTCH | | |
| Type 0B PDCCH CSS for | Dedicated RRC | Up to UE (or |
| searchSpaceMulticastMCCH/ | Uplink Transmission | Transmit Uplink) |
| searchSpaceMulticastMTCH | | |
| Type 0/0B PDCCH CSS for | Other uplink | Up to UE |
| searchSpaceMulticastMCCH/ | transmission | |
| searchSpaceMulticastMTCH | | |

In this example, the collision handling rule may define the action as based on implementation of the network entity. The collision handling rule in this example may be independent from the communication type of the uplink transmission (e.g., for both dedicated-RRC-configured and non-dedicated-RRC-configured uplink transmissions) that collides with PDCCH monitoring in the type OB CSS set. The collision handling rule in this example may be independent of whether the PDCCH monitoring is in the transport channel (MTCH) or the control channel (MCCH) for the MBS multicast transmission. In this example, the type 0 CSS set and the type OB CSS set are to be defined separately. That is, the different collision handling rules may be applied when the collision condition exists between the uplink transmission and PDCCH monitoring in the type 0 CSS set or the type OB CSS set.

In another collision handling rule shown in Table 4b, the collision handling rule may define the action as the network entity performing the uplink transmission when the communication type of the uplink transmission is the dedicated-RRC-configured uplink transmission. This example may include the condition handling rule being independent from whether the network entity is monitoring PDCCH in the transport channel or the control channel. In this example, the type 0 CSS set and the type OB CSS set are to be defined separately. That is, the different collision handling rules may be applied when the collision condition exists between the uplink transmission and PDCCH monitoring in the type 0 CSS set or the type OB CSS set.

In some aspects of the examples shown in Table 4b for MBS multicast, for MBS multicast when the UE is operating in the RRC inactive state, it may be specified that cfr-ConfigMCCH-MTCH-Multicast (configured in SIB), separate from broadcast CFR, can be configured for PDCCH and PDSCH receptions providing multicast MCCH/MTCH for UEs in the RRC inactive state. For example, it may be specified that a UE can be configured by cfr-ConfigMCCH-MTCH-Multicast in a MBS frequency resource for PDCCH and PDSCH receptions providing multicast MCCH and multicast MTCH while operating in the RRC inactive state. Otherwise, the MBS frequency resource may be the same as for the CORESET with index 0 that is associated with the Type0-PDCCH CSS set for PDCCH and PDSCH receptions providing multicast MCCH and multicast MTCH while the UE operates in the RRC inactive state. A UE may monitor PDCCH for scheduling PDSCH receptions for multicast MCCH or multicast MTCH in the RRC inactive state. A UE operating in the RRC connected state may not be required to monitor searchSpaceMCCH-Multicast/searchSpaceMTCH-Multicast in cfr-ConfigMCCH-MTCH-Multicast.

Therefore, for half-duplex FDD reduced capability UEs, this may be resolved without being implemented in the relevant standards or guidelines. Alternatively, it may be specified that the collision could happen if the active downlink BWP fully confines cfr-ConfigMCCH-MTCH-Multicast with the same SCS/CP and it may be up to UE implementation to transmit the uplink transmission based on dedicated RRC-configuration.

A half-duplex UE may not expect to receive both a Type-0/0A/1/2-PDCCH CSS set configuration for PDCCH reception in a set of symbols and dedicated higher layer parameters configuring transmission in the set of symbols. If the half-duplex UE receives a Type-0B CSS set configuration for PDCCH reception in searchSpaceMCCH-Multicast or searchSpaceMTCH-Multicast in a set of symbols and dedicated higher layer parameters configuration transmission in the set of symbols, if the active downlink BWP and an MBS frequency resource provided by cfr-ConfigMCCH-MTCH-Multicast or determined by CORESET with index 0 when cfr-ConfigMCCH-MTCH-Multicast is not provided for a UE have the same SCS and same CP length and the active downlink BWP includes all resource blocks of the MBS frequency resource, the half-duplex UE may select based on its implementation whether to transmit the dedicated higher layer parameters configuration transmission (e.g., perform the uplink transmission) in the set of symbols.

Another example of such collision handling rules for a collision condition between the PDCCH monitoring in the type OB CSS set and the uplink transmission is shown in Table 4c below.

TABLE 4c

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC | Error Case (Error |
| searchSpaceMulticastMCCH | Uplink Transmission | Condition) |
| Type 0/0B PDCCH CSS for | Dedicated RRC | Up to UE (or |
| searchSpace MulticastMTCH | Uplink Transmission | Transmit |
| | | Uplink)CN; |
| Type 0/0B PDCCH CSS for | Other uplink | Up to UE |
| searchSpace MulticastMCCH/ | transmission | |
| searchSpace MulticastMTCH | | |

In this example, the collision handling rule may define the action as an error condition when the communication type of the uplink transmission is dedicated-RRC-configured and when the PDCCH monitoring includes the control channel (MCCH) of the MBS multicast transmission. The collision handling rule may define the action as based on implementation of the network entity when the communication type of the uplink transmission is dedicated RRC-configured and when the PDCCH monitoring includes the transport channel (MTCH) of the MBS multicast transmission. Alternatively, the collision handling rule may define the action as the network entity performing the uplink transmission when the communication type of the uplink transmission is dedicated-RRC-configured and when the PDCCH monitoring includes the transport channel (MTCH) of the MBS multicast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

In another collision handling rule shown in Table 4c, the collision handling rule may define the action as based on implementation of the network entity when the communication type of the uplink transmission is non-dedicated-RRC-configured. This example may be independent from whether the PDCCH monitoring includes the transport channel (MTCH) or the control channel (MCCH) of the MBS multicast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

Another example of such collision handling rules for a collision condition between the PDCCH monitoring in the type OB CSS set and the uplink transmission is shown in Table 4d below.

TABLE 4d

| | Communication | |
|---|---|---|
| Type of PDCCH monitoring | Type of Uplink | Collision |
| in the SS set | Transmission | Handling Rule |
| Type 0 PDCCH CSS for | Dedicated RRC | Error Case (Error |
| searchSpaceMCCH-Multicast | Uplink Transmission | Condition) |
| Type 0B PDCCH CSS for | Dedicated RRC | Up to UE (or |
| searchSpaceMulticastMCCH | Uplink Transmission | Transmit Uplink) |
| or Type 0/0B CSS for | | |
| searchSpaceMulticastMTCH | | |
| Type 0/0B PDCCH CSS for | Other uplink | Up to UE |
| searchSpaceMulticastMCCH/ | transmission | |
| searchSpaceMulticastMTCH | | |

In this example, the collision handling rule may define the action as based on implementation of the network entity (e.g., whether to perform the uplink transmission). This example may be independent of the communication type of the uplink transmission (e.g., for both dedicated-RRC-configured and non-dedicated-RRC-configured uplink transmissions). This example may be independent of whether the PDCCH monitoring is in the transport channel or in the control channel of the MBS multicast transmission. In this example, the type 0 CSS set and the type OB CSS set are to be defined separately. For example, the type 0 CSS set and the type OB CSS set may be defined separately when the PDCCH monitoring includes the control channel (MCCH) or may be defined jointly when the PDCCH monitoring includes the transport channel (MTCH). That is, different collision handling rules may be applied when the collision condition exists between the uplink transmission and PDCCH monitoring in the type 0 CSS set and in the type OB CSS set.

In another collision handling rule shown in Table 4d, the collision handling rule may define the action as based on implementation of the network entity when the communication type of the uplink transmission is non-dedicated-RRC-configured. This example may be independent from whether the PDCCH monitoring includes the transport channel (MTCH) or the control channel (MCCH) of the MBS multicast transmission. In this example, the type 0 CSS set and the type OB CSS set are to be defined separately. That is, different collision handling rules may be applied when the collision condition exists between the uplink transmission and PDCCH monitoring of MCCH/MTCH in the type 0 CSS set and in the type OB CSS set.

Another example of such collision handling rules for a collision condition between the PDCCH monitoring in the type OB CSS set and the uplink transmission is shown in Table 4e below.

TABLE 4e

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC | Error Case (Error |
| searchSpaceMulticastMTCH | Uplink Transmission | Condition) |
| Type 0/0B PDCCH CSS for | Dedicated RRC | Up to UE (or |
| searchSpaceMulticastMCCH | Uplink Transmission | Transmit Uplink) |
| Type 0/0B PDCCH CSS for | Other uplink | Up to UE |
| searchSpaceMulticastMCCH/ | transmission | |
| searchSpaceMulticastMTCH | (including cell- | |
| | specific uplink) | |

In this example, the collision handling rule may define the action as an error condition when the communication type of the uplink transmission is dedicated-RRC-configured and when the PDCCH monitoring includes the transport channel (MTCH) of the MBS multicast transmission. The collision handling rule may define the action as based on implementation of the network entity when the communication type of the uplink transmission is dedicated-RRC-configured and when the PDCCH monitoring includes the control channel (MCCH) of the MBS multicast transmission.

Alternatively, the collision handling rule may define the action as the network entity performing the uplink transmission when the communication type of the uplink transmission is dedicated-RRC-configured and when the PDCCH monitoring includes the control channel (MCCH) of the MBS multicast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

In another collision handling rule shown in Table 4e, the collision handling rule may define the action as based on implementation of the network entity when the communication type of the uplink transmission are non-dedicated-RRC-configured uplink transmissions. This example may be independent from whether the PDCCH monitoring includes the transport channel (MTCH) or the control channel (MCCH) of the MBS multicast transmission. In this example, the type 0 CSS set and the type OB CSS set may again be defined jointly. That is, the same collision handling rules may be applied when the collision condition exists between the uplink transmission and PDCCH monitoring of MCCH/MTCH in the type 0 CSS set and in the type OB CSS set.

Another example of such collision handling rules for a collision condition between the PDCCH monitoring in the type OB CSS set and the uplink transmission is shown in Table 4f below.

TABLE 4f

| | Communication | |
|---|---|---|
| Type of PDCCH monitoring | Type of Uplink | Collision |
| in the SS set | Transmission | Handling Rule |
| Type 0 PDCCH CSS for | Dedicated | Error Case (Error |
| searchSpaceMulticastMTCH | RRC Uplink | Condition) |
| | Transmission | |
| Type 0B PDCCH CSS for | Dedicated | Up to UE (or |
| searchSpaceMulticastMTCH or | RRC Uplink | Transmit Uplink) |
| Type 0/0B PDCCH CSS for | Transmission | |
| searchSpaceMulticastMCCH | | |
| Type 0/0B PDCCH CSS for | Other uplink | Up to UE |
| searchSpaceMulticastMCCH/ | transmission | |
| searchSpaceMulticastMTCH | | |

In this example, the collision handling rule may define the action as based on implementation of the network entity (e.g., the network entity may perform the uplink transmission). This example may be independent of the communication type of the uplink transmission (e.g., for both dedicated-RRC-configured and non-dedicated-RRC-configured uplink transmissions). This example may be independent of whether the PDCCH monitoring includes the control channel (MCCH) or the transport channel (MTCH) of the MBS multicast transmission. In this example, the type 0 CSS set and the type OB CSS set are to be defined separately. For example, the type 0 CSS set and the type OB CSS set may be defined separately when the PDCCH monitoring includes the transport channel (MTCH) or may be defined jointly when the PDCCH monitoring includes the control channel (MCCH). That is, different collision handling rules or the same collision handling rules may be applied when the collision condition exists between the uplink transmission and PDCCH monitoring in the type 0 CSS set and in the type OB CSS set.

Another example of such collision handling rules for a collision condition between the PDCCH monitoring in the type OB CSS set and the uplink transmission is shown in Table 4g below.

TABLE 4g

| | Communication | |
|---|---|---|
| Type of PDCCH monitoring | Type of Uplink | Collision |
| in the SS set | Transmission | Handling Rule |
| Type 0/0B PDCCH CSS for | Dedicated RRC or | Up to UE |
| searchSpaceMulticastMCCH/ | Other uplink | |
| searchSpaceMulticastMTCH | transmission | |

In this example, the collision handling rule may define the action as based on implementation of the network entity. This example may be independent of the communication type of the uplink transmission (e.g., for both dedicated-RRC-configured and non-dedicated-RRC-configured uplink transmissions). This example may be independent of whether the PDCCH monitoring includes the control channel (MCCH) or the transport channel (MTCH) of the MBS multicast transmission. In this example, the type 0 CSS set and the type OB CSS set are to be defined jointly. That is, the same collision handling rules may be applied when the collision condition exists between the uplink transmission and PDCCH monitoring in the type 0 CSS set and in the type OB CSS set.

Accordingly, wireless communications system 200 illustrates a non-limiting example of collision handling rules that may be applied by the network entity (e.g., the UE 205) and the network (e.g., the network entity 210) when a collision condition occurs. The collision condition may be based on a temporal overlap (partially or fully) between PDCCH monitoring in a SS set and an uplink transmission scheduled for the network entity. The various collision handling rules described herein may be applied by the network entity, by the network, or be applied by both devices, upon occurrence of the collision condition. The collision handling rules may be based on the type of SS set in which the PDCCH monitoring is to occur, based on the communication type of the uplink transmission (in some examples), or based on whether the PDCCH monitoring occurs in a transport channel or a control channel.

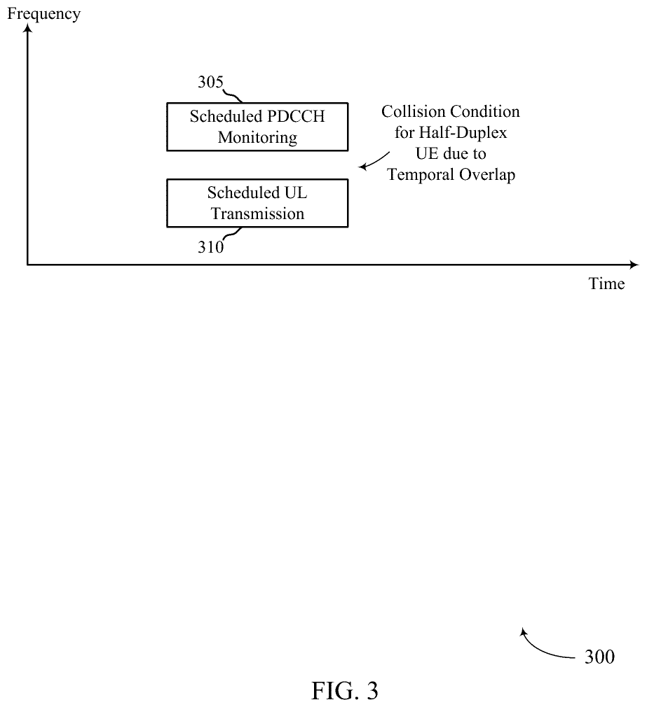

FIG. 3 shows an example of a collision condition 300 that supports SS monitoring for half-duplex UE in accordance with one or more aspects of the present disclosure. Aspects of collision condition 300 may implement aspects of wireless communications system 100 or wireless communications system 200. Aspects of collision condition 300 may be implemented at or implemented by a network entity or a different network device(s), which may be examples of the corresponding devices described herein. For example, the network entity may be an example of a UE that operates in a half-duplex mode. The other network device(s) may be an example of a base station or other wireless component within the RAN.

As discussed above, aspects of the described techniques may provide for collision handling rules that may be applied when a collision condition occurs. For example, the network entity may receive or obtain information that configured PDCCH monitoring 305 in a SS set. The network entity may receive or otherwise obtain control information that indicates an uplink transmission 310. However, a collision condition may exist between the PDCCH monitoring 305 and the uplink transmission 310. The network entity operating in a half-duplex mode may perform an action in accordance with the collision handling rules described herein. For example, the action may be based on implementation of the network entity (e.g., the network entity may select the action). The action may be that the collision condition and collision handling rules define an error condition. The action may be that the network entity performs the uplink transmission 310. The action may be that the network entity performs the PDCCH monitoring 305 in the SS set.

More particularly, the collision condition may exist when the SS set for the PDCCH monitoring 305 is within a first time period and the uplink transmission 310 is scheduled to occur during a second time period that (at least partially) overlaps with the first time period. As discussed, the first and second time periods may partially (e.g. while FIG. 3 shows configured PDCCH monitoring 305 as coterminous with scheduled UL transmission 310, this need not be the case) or fully overlap in the time domain (e.g., a temporal overlap).

In some aspects, the PDCCH monitoring 305 in the SS set may be configured in a first frequency resources (e.g., channel) that is different from second frequency resources for the scheduled uplink transmission 310. The network, the network entity, or both, may generally treat or consider the first and second frequency resources as a paired spectrum, such as to support FDD operations.

Collision condition 300 illustrates a non-limiting example of the collision condition that, upon occurrence, may result in application of the described collision handling rules. In this example, the collision condition may exist when there is a temporal overlap between the PDCCH monitoring 305 and the uplink transmission 310. The overlap may be a partial overlap or may be a full overlap in the time domain (as shown). The collision condition may be an actual collision condition, such as the network entity being scheduled or otherwise configured to perform both the PDCCH monitoring 305 in the SS set and the uplink transmission 310. The collision condition may be a potential collision condition, such as the network entity being scheduled to perform the PDCCH monitoring 305 and have access to uplink resources for the uplink transmission 310 (without being configured or otherwise expected to use those uplink resources). The collision condition may be a potential collision condition, such as the network entity being scheduled to perform the uplink transmission 310 and having access to the PDCCH monitoring 305 (without being configured or otherwise expected to use those uplink resources).

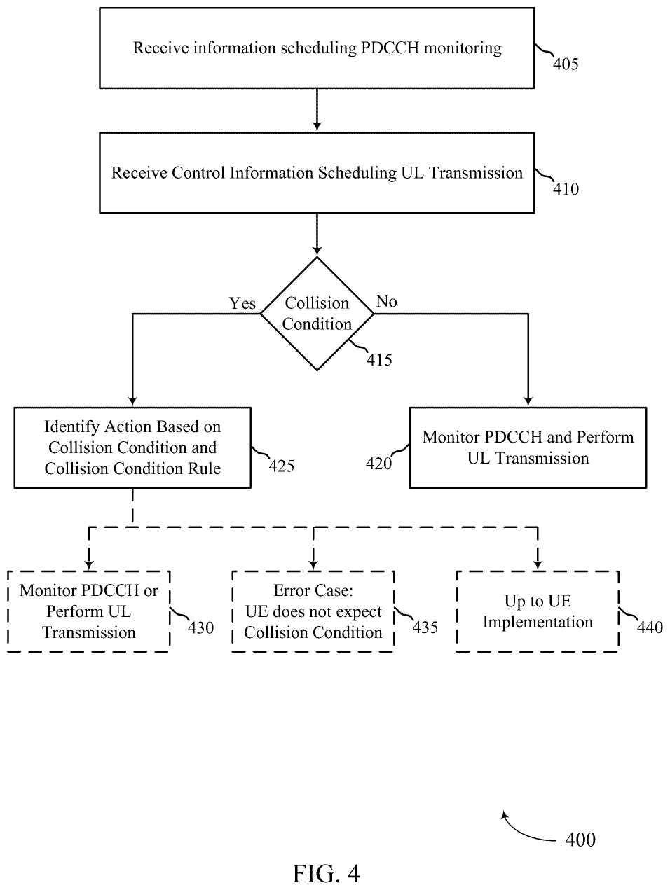

FIG. 4 shows an example of a method 400 that supports SS monitoring for half-duplex UE in accordance with one or more aspects of the present disclosure. Method 400 may implement aspects of wireless communications system 100, wireless communications system 200, or collision condition 300. Aspects of method 400 may be implemented at or implemented by a network entity, which may be an example of the corresponding device described herein. For example, the network entity may be an example of a UE. The UE may be operating in a half-duplex mode.

At 405, the network entity may receive or otherwise obtain information scheduling PDCCH monitoring in a SS set. The information may carry or otherwise convey an indication of time resources, frequency resources, spatial resource, or code resources that the network entity will use to monitor the SS set. The SS set may be a type OB CSS set, a type 1A CSS set, or a type 2A CSS set.

At 410, the network entity may receive or otherwise obtain control information that indicates an uplink transmission. The uplink transmission may be a dedicated-RRC-configured uplink transmission or a non-dedicated-RRC-configured uplink transmission. The control information may identify or otherwise indicate time resources, frequency resources, spatial resources, or code resources, to be used by the network entity to perform the uplink transmission.

At 415, the network entity may identify or otherwise determine whether a collision condition exists between the PDCCH monitoring in the SS set and the uplink transmission. For example, a collision condition may exist when the PDCCH monitoring in the SS set and the uplink transmission are scheduled to occur in at least partially overlapping time periods. That is, a temporal overlap between the PDCCH monitoring in the SS set and the uplink transmission may present a collision condition based on the network entity operating in a half-duplex mode.

If no collision condition exists, at 420 the network entity may perform the PDCCH monitoring in the SS set and perform the uplink transmission according to the corresponding information and control information. For example, the network entity may use the resources identified in the information and in the control information to perform both actions.

If the collision condition exists (e.g., an actual collision condition or a potential collision condition), at 425 the network entity may select, identify, or otherwise determine an action to take based on the collision condition and the collision handling rules described herein. Application of the collision handling rules may include various optional actions by the network entity in view of the collision condition.

One optional action may include, at 430, the network entity either performing the PDCCH monitoring in the SS set or performing the uplink transmission. For example, the network entity may only perform the PDCCH monitoring in the SS set according to the collision handling rules in response to the collision condition occurring. As another example, the network entity may only perform the uplink transmission according to the collision handling rules in response to the collision condition occurring.

Another optional action may include, at 435, the network entity declaring an error condition (e.g., the collision condition may be an error case). The error condition may be based on an expectation or assumption by the network entity that the network entity will not be scheduled for a collision between the PDCCH monitoring in the SS set and the uplink transmission. For example, the error case may be associated with an error in the network when such collisions occur.

Another optional action may include, at 440, the network entity selecting which action to take in response to the collision condition. For example, the collision handling rule may define the action as being based on implementation of the network entity. This may enable the network entity to select or otherwise choose between perform the PDCCH monitoring in the SS set or performing the uplink transmission.

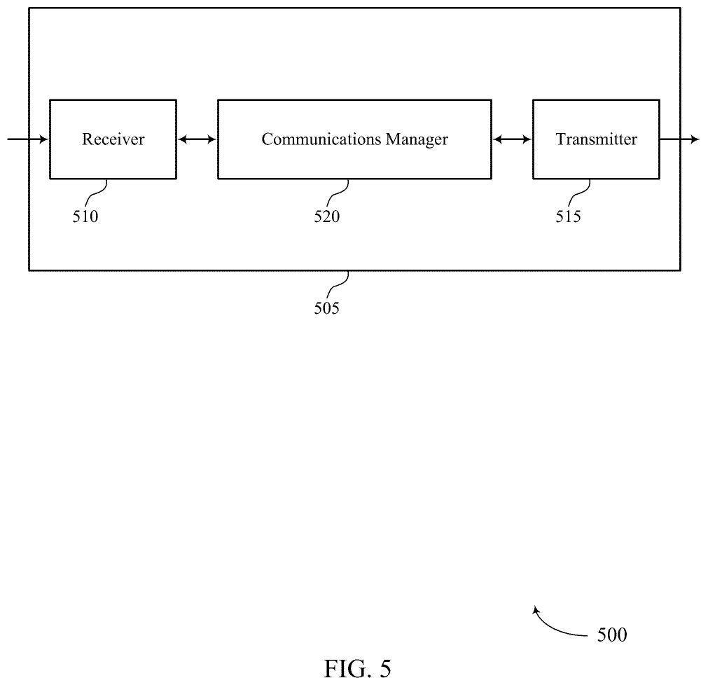

FIG. 5 shows a block diagram 500 of a device 505 that supports SS monitoring for half-duplex UE in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to SS monitoring for half-duplex UE). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SS monitoring for half-duplex UE). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of SS monitoring for half-duplex UE as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving information that configures PDCCH monitoring in a SS set. The communications manager 520 is capable of, configured to, or operable to support a means for receiving control information that indicates an uplink transmission, where a collision condition exists between the PDCCH monitoring in the SS set and the uplink transmission. The communications manager 520 is capable of, configured to, or operable to support a means for performing, during operation in a half-duplex mode, an action in accordance with a collision handling rule, where the collision handling rule is based on the collision condition and the SS set.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for collision handling rules to be defined for when an uplink transmission is indicated to a network entity that collides in the time domain with PDCCH monitoring in a type OB CSS set, a type 1A CSS set, or a type 2A CSS set.

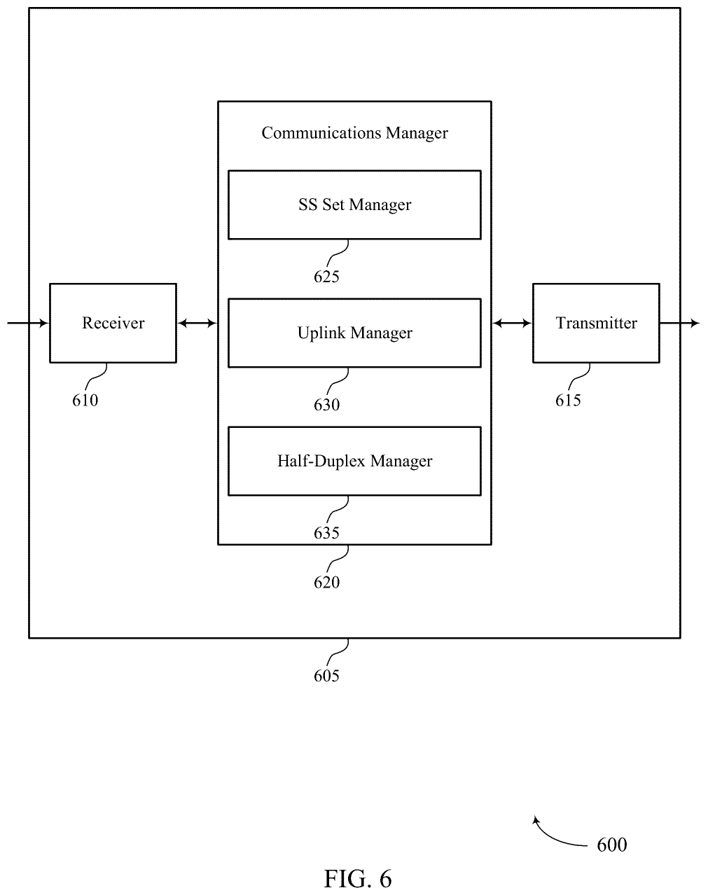

FIG. 6 shows a block diagram 600 of a device 605 that supports SS monitoring for half-duplex UE in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to SS monitoring for half-duplex UE). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SS monitoring for half-duplex UE). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SS monitoring for half-duplex UE as described herein. For example, the communications manager 620 may include an SS set manager 625, an uplink manager 630, a half-duplex manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The SS set manager 625 is capable of, configured to, or operable to support a means for receiving information that configures PDCCH monitoring in a SS set. The uplink manager 630 is capable of, configured to, or operable to support a means for receiving control information that indicates an uplink transmission, where a collision condition exists between the PDCCH monitoring in the SS set and the uplink transmission. The half-duplex manager 635 is capable of, configured to, or operable to support a means for performing, during operation in a half-duplex mode, an action in accordance with a collision handling rule, where the collision handling rule is based on the collision condition and the SS set.

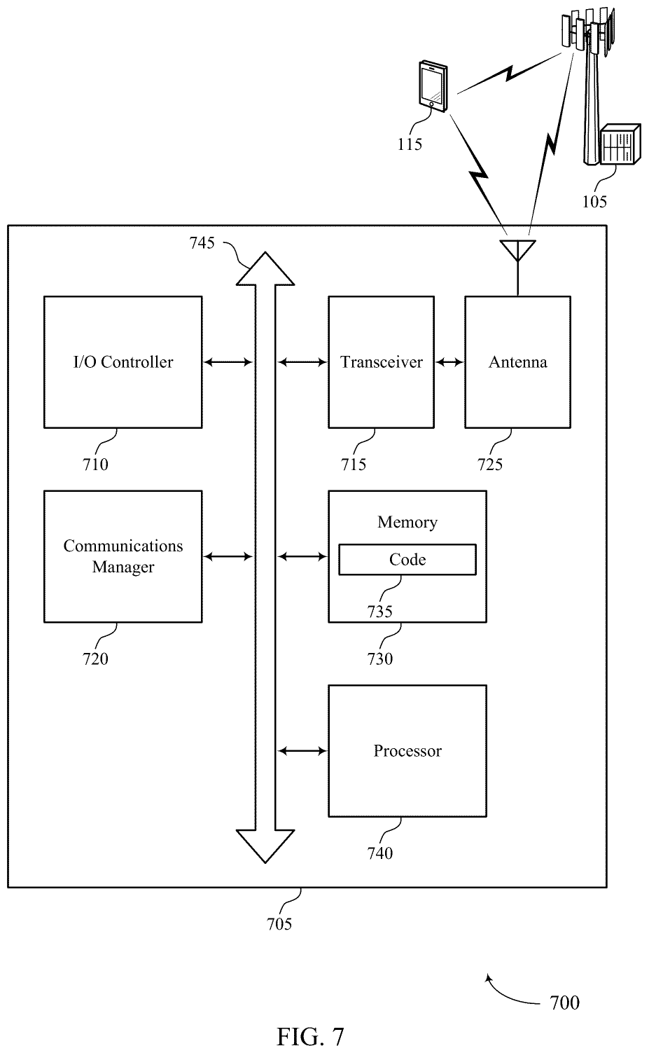

FIG. 7 shows a diagram of a system 700 including a device 705 that supports SS monitoring for half-duplex UE in accordance with one or more aspects of the present disclosure. The device 705 may be an example of or include the components of a device 505, a device 605, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of one or more processors, such as the at least one processor 740.

In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 515, a transmitter 615, a receiver 510, a receiver 610, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting SS monitoring for half-duplex UE). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for receiving information that configures PDCCH monitoring in a SS set. The communications manager 720 is capable of, configured to, or operable to support a means for receiving control information that indicates an uplink transmission, where a collision condition exists between the PDCCH monitoring in the SS set and the uplink transmission. The communications manager 720 is capable of, configured to, or operable to support a means for performing, during operation in a half-duplex mode, an action in accordance with a collision handling rule, where the collision handling rule is based on the collision condition and the SS set.

By including or configuring the communications manager 720 in accordance with examples as described herein, the device 705 may support techniques for collision handling rules to be defined for when an uplink transmission is indicated to a network entity that collides in the time domain with PDCCH monitoring in a type OB CSS set, a type 1A CSS set, or a type 2A CSS set.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of SS monitoring for half-duplex UE as described herein, or the at least one processor 740 and the at least one memory 730 may be otherwise configured to, individually or collectively, perform or support such operations.

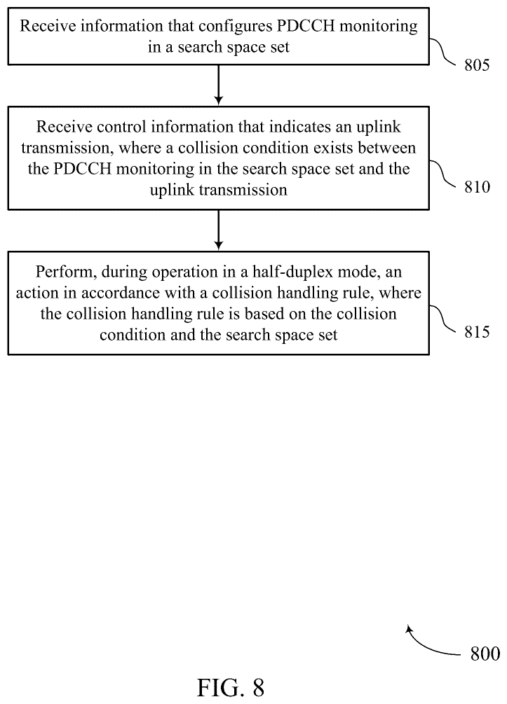

FIG. 8 shows a flowchart illustrating a method 800 that supports SS monitoring for half-duplex UE in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving information that configures PDCCH monitoring in a SS set. The operations of block 805 may be performed in accordance with examples as disclosed herein.

At 810, the method may include receiving control information that indicates an uplink transmission, where a collision condition exists between the PDCCH monitoring in the SS set and the uplink transmission. The operations of block 810 may be performed in accordance with examples as disclosed herein.

At 815, the method may include performing, during operation in a half-duplex mode, an action in accordance with a collision handling rule, where the collision handling rule is based on the collision condition and the SS set. The operations of block 815 may be performed in accordance with examples as disclosed herein.

The following provides an overview of aspects of the present disclosure:
Aspect 1: A method for wireless communication at a network entity, comprising: receiving information that configures PDCCH monitoring in a SS set; receiving control information that indicates an uplink transmission, wherein a collision condition exists between the PDCCH monitoring in the SS set and the uplink transmission; and performing, during operation in a half-duplex mode, an action in accordance with a collision handling rule, wherein the collision handling rule is based on the collision condition and the SS set.
Aspect 2: The method of aspect 1, wherein the SS set is a type 2A CSS set, the PDCCH monitoring is for monitoring for a PEI, and the collision handling rule for the type 2A CSS set is different from a type 2 CSS set collision handling rule.
Aspect 3: The method of aspect 2, wherein the collision handling rule defines the action as an error condition when a communication type of the uplink transmission is a dedicated-RRC-configured uplink transmission and defines the action as based on implementation of the network entity when the communication type is a non-dedicated-RRC-configured uplink transmission.
Aspect 4: The method of aspect 3, wherein the error condition is an assumption regarding non-occurrence of a collision between the PDCCH monitoring in the SS set and the uplink transmission.
Aspect 5: The method of any of aspects 2 through 4, wherein the collision handling rule defines the action as being based on implementation of the network entity, and the collision handling rule is independent from a communication type of the uplink transmission.
Aspect 6: The method of any of aspects 2 through 5, wherein the collision handling rule defines the action as being based on implementation of the network entity when a communication type of the uplink transmission is a non-dedicated-RRC-configured uplink transmission and defines the action as performing the uplink transmission when the communication type is a dedicated-RRC-configured uplink transmission.
Aspect 7: The method of any of aspects 1 through 6, wherein the SS set is a type 1A CSS set, the PDCCH monitoring is for monitoring for a SDT, and the type 1A CSS set is different from a type 1 CSS set.
Aspect 8: The method of aspect 7, wherein the collision handling rule defines the action as an error condition when a communication type of the uplink transmission is a dedicated-RRC-configured uplink transmission and defines the action as based on implementation of the network entity when the communication type is a non-dedicated-RRC-configured uplink transmission, and the collision handling rule for the type 1A CSS set and a type 1 CSS set collision handling rule are defined jointly.
Aspect 9: The method of aspect 8, wherein the error condition is an assumption regarding non-occurrence of a collision between the PDCCH monitoring in the SS set and the uplink transmission.
Aspect 10: The method of any of aspects 7 through 9, wherein the collision handling rule defines the action as based on implementation of the network entity, the collision handling rule is independent from a communication type of the uplink transmission, and the collision handling rule for the type 1A CSS set and a type 1 CSS set collision handling rule are defined separately.
Aspect 11: The method of any of aspects 7 through 10, wherein the collision handling rule defines the action as based on implementation of the network entity, the collision handling rule is independent from a communication type of the uplink transmission, and the collision handling rule for the type 1A CSS set and a type 1 CSS set collision handling rule are defined jointly.
Aspect 12: The method of any of aspects 7 through 11, wherein the collision handling rule defines the action as an error condition when a communication type of the uplink transmission is a dedicated-RRC-configured uplink transmission and defines the action as based on implementation of the network entity when the communication type is a non-dedicated-RRC-configured uplink transmission, and the collision handling rule for the type 1A CSS set and a type 1 CSS set collision handling rule are defined separately.
Aspect 13: The method of aspect 12, wherein the error condition is an assumption regarding non-occurrence of a collision between the PDCCH monitoring in the SS set and the uplink transmission.
Aspect 14: The method of any of aspects 1 through 13, wherein the SS set is a type OB CSS set, the PDCCH monitoring is for monitoring for an MBS broadcast transmission, and the type OB CSS set is different from a type 0 CSS set.
Aspect 15: The method of aspect 14, wherein the collision handling rule defines the action as an error condition when a communication type of the uplink transmission is a dedicated-RRC-configured uplink transmission and defines the action as based on implementation of the network entity when the communication type is a non-dedicated-RRC-configured uplink transmission, the collision handling rule is independent from the PDCCH monitoring including a transport channel or a control channel of the MBS transmission, and the collision handling rule for the type OB CSS set and a type 0 CSS set collision handling rule are defined jointly.
Aspect 16: The method of aspect 15, wherein the error condition is an assumption regarding non-occurrence of a collision between the PDCCH monitoring in the SS set and the uplink transmission.
Aspect 17: The method of any of aspects 14 through 16, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined separately.
Aspect 18: The method of any of aspects 14 through 17, wherein the collision handling rule defines the action as performing the uplink transmission when a communication type of the uplink transmission is a dedicated-RRC-configured uplink transmission, the collision handling rule is independent from the PDCCH monitoring including a transport channel or a control channel of the MBS transmission, and the collision handling rule for the type OB CSS set and a type 0 CSS set collision handling rule are defined separately.
Aspect 19: The method of any of aspects 14 through 18, wherein the collision handling rule defines the action as an error condition when a communication type of the uplink transmission is a dedicated-RRC-configured uplink transmission and when the PDCCH monitoring includes a control channel of the MBS transmission and defines the action as based on implementation of the network entity when the communication type is the dedicated-RRC-configured uplink transmission and when the PDCCH monitoring includes a transport channel of the MBS transmission, and the collision handling rule for the type OB CSS set and a type 0 CSS set collision handling rule are defined jointly.
Aspect 20: The method of aspect 19, wherein the error condition is an assumption regarding non-occurrence of a collision between the PDCCH monitoring in the SS set and the uplink transmission.
Aspect 21: The method of any of aspects 14 through 20, wherein the collision handling rule defines the action as based on implementation of the network entity when a communication type of the uplink transmission is a non-dedicated-RRC-configured uplink transmission, the collision handling rule is independent of the PDCCH monitoring including a transport channel or a control channel of the MBS transmission, and the collision handling rule for the type OB CSS set and a type 0 CSS set collision handling rule are defined jointly.
Aspect 22: The method of any of aspects 14 through 21, wherein the collision handling rule defines the action as based on implementation of the network entity when a communication type of the uplink transmission is a dedicated-RRC-configured uplink transmission, the collision handling rule is independent of the PDCCH monitoring including a transport channel or a control channel of the MBS transmission, and the collision handling rule for the type OB CSS set and a type 0 CSS set collision handling rule are defined separately.
Aspect 23: The method of any of aspects 14 through 22, wherein the collision handling rule defines the action as an error condition when a communication type of the uplink transmission is a dedicated-RRC-configured uplink transmission and when the PDCCH monitoring includes a transport channel of the MBS transmission and defines the action as based on implementation of the network entity when the communication type is the dedicated-RRC-configured uplink transmission and when the PDCCH monitoring includes a control channel of the MBS transmission, and the collision handling rule for the type OB CSS set and a type 0 CSS set collision handling rule are defined jointly.
Aspect 24: The method of aspect 23, wherein the error condition is an assumption regarding non-occurrence of a collision between the PDCCH monitoring in the SS set and the uplink transmission.
Aspect 25: The method of any of aspects 14 through 24, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined jointly.
Aspect 26: The method of any of aspects 14 through 25, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined separately.
Aspect 27: The method of any of aspects 14 through 26, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined jointly.
Aspect 28: The method of any of aspects 1 through 27, wherein the SS set is a type OB CSS set, the PDCCH monitoring is for monitoring an MBS multicast transmission, the collision handling rule for the type OB CSS set is different from a type 0 CSS set collision handling rule.
Aspect 29: The method of aspect 28, wherein the collision handling rule defines the action as an error condition when a communication type of the uplink transmission is a dedicated-RRC-configured uplink transmission and defines the action as based on implementation of the network entity when the communication type is a non-dedicated-RRC-configured uplink transmission, the collision handling rule is independent from the PDCCH monitoring including a transport channel or a control channel of the MBS transmission, and the collision handling rule for the type OB CSS set and a type 0 CSS set collision handling rule are defined jointly.
Aspect 30: The method of aspect 29, wherein the error condition is an assumption regarding non-occurrence of a collision between the PDCCH monitoring in the SS set and the uplink transmission.
Aspect 31: The method of any of aspects 28 through 30, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined separately.
Aspect 32: The method of any of aspects 28 through 31, wherein the collision handling rule defines the action as performing the uplink transmission when a communication type of the uplink transmission is a dedicated-RRC-configured uplink transmission, the collision handling rule is independent from the PDCCH monitoring including a transport channel or a control channel of the MBS transmission, and the collision handling rule for the type OB CSS set and a type 0 CSS set collision handling rule are defined separately.
Aspect 33: The method of any of aspects 28 through 32, wherein the collision handling rule defines the action as an error condition when a communication type of the uplink transmission is a dedicated-RRC-configured uplink transmission and when the PDCCH monitoring includes a control channel of the MBS transmission and defines the action as based on implementation of the network entity when the communication type is the dedicated-RRC-configured uplink transmission and when the PDCCH monitoring includes a transport channel of the MBS transmission, and the collision handling rule for the type OB CSS set and a type 0 CSS set collision handling rule are defined jointly.
Aspect 34: The method of aspect 33, wherein the error condition is an assumption regarding non-occurrence of a collision between the PDCCH monitoring in the SS set and the uplink transmission.
Aspect 35: The method of any of aspects 28 through 34, wherein the collision handling rule defines the action as based on implementation of the network entity when a communication type of the uplink transmission is a non-dedicated-RRC-configured uplink transmission, the collision handling rule is independent of the PDCCH monitoring including a transport channel or a control channel of the MBS transmission, and the collision handling rule for the type OB CSS set and a type 0 CSS set collision handling rule are defined jointly.
Aspect 36: The method of any of aspects 28 through 35, wherein the collision handling rule defines the action as based on implementation of the network entity, the collision handling rule is independent from a communication type of the uplink transmission, the collision handling rule is independent of the PDCCH monitoring including a transport channel or a control channel of the MBS transmission, and the collision handling rule for the type OB CSS set and a type 0 CSS set collision handling rule are defined separately.
Aspect 37: The method of any of aspects 28 through 36, wherein the collision handling rule defines the action as an error condition when a communication type of the uplink transmission is a dedicated-RRC-configured uplink transmission and when the PDCCH monitoring includes a transport channel of the MBS transmission and defines the action as based on implementation of the network entity when the communication type is the dedicated-RRC-configured uplink transmission and when the PDCCH monitoring includes a control channel of the MBS transmission, and the collision handling rule for the type OB CSS set and a type 0 CSS set collision handling rule are defined jointly.
Aspect 38: The method of aspect 37, wherein the error condition is an assumption regarding non-occurrence of a collision between the PDCCH monitoring in the SS set and the uplink transmission.
Aspect 39: The method of any of aspects 28 through 38, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined jointly.
Aspect 40: The method of any of aspects 28 through 39, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined separately.
Aspect 41: The method of any of aspects 28 through 40, wherein the collision handling rule defines the action as based on implementation of the network entity, the collision handling rule is independent from a communication type of the uplink transmission, the collision handling rule is independent from the PDCCH monitoring including a transport channel or a control channel of the MBS transmission, and the collision handling rule for the type OB CSS set and a type 0 CSS set collision handling rule are defined jointly.
Aspect 42: The method of any of aspects 1 through 41, wherein the network entity is a UE.
Aspect 43: The method of any of aspects 1 through 42, wherein the collision condition is a potential collision condition.
Aspect 44: The method of any of aspects 1 through 43, wherein the collision condition is an actual collision condition.
Aspect 45: The method of any of aspects 1 through 44, wherein the collision condition exists between the SS set for the PDCCH monitoring and the uplink transmission based on a temporal overlap between the SS set for the PDCCH monitoring and the uplink transmission.
Aspect 46: The method of any of aspects 1 through 45, wherein the SS set for the PDCCH monitoring is within a first time period and the uplink transmission is scheduled to occur during a second time period, and the collision condition exists between the SS set for the PDCCH monitoring and the uplink transmission based on an overlap of the first time period and the second time period.
Aspect 47: The method of any of aspects 1 through 46, wherein operations in the half-duplex mode are associated with FDD operations, and the PDCCH monitoring of the SS set and the uplink transmission are in a paired spectrum.
Aspect 48: The method of any of aspects 1 through 47, wherein the action is only performing the uplink transmission based on occurrence of the collision condition.
Aspect 49: The method of any of aspects 1 through 48, wherein the action is only performing the PDCCH monitoring in the SS set.
Aspect 50: The method of any of aspects 1 through 49, wherein the collision condition is an actual collision condition and the network entity selects whether to perform the uplink transmission or to perform the PDCCH monitoring in the SS set.
Aspect 51: A network entity for wireless communication, comprising one or more memories storing processor-executable code, and one or more processors coupled with the one or more memories and individually or collectively operable to execute the code to cause the network entity to perform a method of any of aspects 1 through 50.
Aspect 52: A network entity for wireless communication, comprising at least one means for performing a method of any of aspects 1 through 50.
Aspect 53: A non-transitory computer-readable medium storing code for wireless communication, the code comprising instructions executable by a processor to perform a method of any of aspects 1 through 50.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive information that configures physical downlink control channel (PDCCH) monitoring for a multicast and broadcast services (MBS) transmission in a type OB common search space set;
receive control information that indicates an uplink transmission, wherein a collision condition exists between the PDCCH monitoring in the type OB common search space set and the uplink transmission; and
perform, during operation in a half-duplex mode, an action in accordance with a collision handling rule, wherein the collision handling rule is based on the collision condition and the type OB common search space set.

2. The network entity of claim 1, wherein:
the PDCCH monitoring is for monitoring for a MBS broadcast transmission, and
the type OB common search space set is different from a type 0 common search space set.

3. The network entity of claim 2, wherein:
the collision handling rule defines the action as an error condition when a communication type of the uplink transmission is a dedicated-radio resource control (RRC)-configured uplink transmission and defines the action as based on implementation of the network entity when the communication type is a non-dedicated-RRC-configured uplink transmission,
the collision handling rule is independent from the PDCCH monitoring including a transport channel or a control channel of the MBS broadcast transmission, and
the collision handling rule for the type OB common search space set and a type 0 common search space set collision handling rule are defined jointly.

4. The network entity of claim 3, wherein the error condition is an assumption regarding non-occurrence of a collision between the PDCCH monitoring in the type OB common search space set and the uplink transmission.

5. The network entity of claim 2, wherein:
the collision handling rule defines the action as based on implementation of the network entity,
the collision handling rule is independent from a communication type of the uplink transmission,
the collision handling rule is independent from the PDCCH monitoring including a transport channel or a control channel of the MBS broadcast transmission, and
the collision handling rule for the type OB common search space set and a type 0 common search space set collision handling rule are defined separately.

6. The network entity of claim 2, wherein:
the collision handling rule defines the action as performing the uplink transmission when a communication type of the uplink transmission is a dedicated-radio resource control (RRC)-configured uplink transmission,
the collision handling rule is independent from the PDCCH monitoring including a transport channel or a control channel of the MBS broadcast transmission, and
the collision handling rule for the type OB common search space set and a type 0 common search space set collision handling rule are defined separately.

7. The network entity of claim 2, wherein:
the collision handling rule defines the action as an error condition when a communication type of the uplink transmission is a dedicated-radio resource control (RRC)-configured uplink transmission and when the PDCCH monitoring includes a control channel of the MBS broadcast transmission and defines the action as based on implementation of the network entity when the communication type is the dedicated-RRC-configured uplink transmission and when the PDCCH monitoring includes a transport channel of the MBS broadcast transmission, and
the collision handling rule for the type OB common search space set and a type 0 common search space set collision handling rule are defined jointly.

8. The network entity of claim 7, wherein the error condition is an assumption regarding non-occurrence of a collision between the PDCCH monitoring in the type OB common search space set and the uplink transmission.

9. The network entity of claim 2, wherein:
the collision handling rule defines the action as based on implementation of the network entity when a communication type of the uplink transmission is a non-dedicated-radio resource control (RRC)-configured uplink transmission,
the collision handling rule is independent of the PDCCH monitoring including a transport channel or a control channel of the MBS broadcast transmission, and
the collision handling rule for the type OB common search space set and a type 0 common search space set collision handling rule are defined jointly.

10. The network entity of claim 2, wherein:
the collision handling rule defines the action as based on implementation of the network entity when a communication type of the uplink transmission is a dedicated-radio resource control (RRC)-configured uplink transmission,
the collision handling rule is independent of the PDCCH monitoring including a transport channel or a control channel of the MBS broadcast transmission, and
the collision handling rule for the type OB common search space set and a type 0 common search space set collision handling rule are defined separately.

11. The network entity of claim 2, wherein:
the collision handling rule defines the action as an error condition when a communication type of the uplink transmission is a dedicated-radio resource control (RRC)-configured uplink transmission and when the PDCCH monitoring includes a transport channel of the MBS broadcast transmission and defines the action as based on implementation of the network entity when the communication type is the dedicated-RRC-configured uplink transmission and when the PDCCH monitoring includes a control channel of the MBS broadcast transmission, and
the collision handling rule for the type OB common search space set and a type 0 common search space set collision handling rule are defined jointly.

12. The network entity of claim 11, wherein the error condition is an assumption regarding non-occurrence of a collision between the PDCCH monitoring in the type OB common search space set and the uplink transmission.

13. The network entity of claim 2, wherein:
the collision handling rule defines the action as based on implementation of the network entity,
the collision handling rule is independent from a communication type of the uplink transmission,
the collision handling rule is independent from the PDCCH monitoring including a transport channel or a control channel of the MBS broadcast transmission, and
the collision handling rule for the type OB common search space set and a type 0 common search space set collision handling rule are defined jointly.

14. The network entity of claim 1, wherein:
the PDCCH monitoring is for monitoring a MBS multicast transmission, and
the collision handling rule for the type OB common search space set is different from a type 0 common search space set collision handling rule.

15. The network entity of claim 14, wherein:
the collision handling rule defines the action as an error condition when a communication type of the uplink transmission is a dedicated-radio resource control (RRC)-configured uplink transmission and defines the action as based on implementation of the network entity when the communication type is a non-dedicated-RRC-configured uplink transmission,
the collision handling rule is independent from the PDCCH monitoring including a transport channel or a control channel of the MBS multicast transmission, and
the collision handling rule for the type OB common search space set and a type 0 common search space set collision handling rule are defined jointly.

16. The network entity of claim 15, wherein the error condition is an assumption regarding non-occurrence of a collision between the PDCCH monitoring in the type OB common search space set and the uplink transmission.

17. The network entity of claim 14, wherein:
the collision handling rule defines the action as based on implementation of the network entity,
the collision handling rule is independent from a communication type of the uplink transmission,
the collision handling rule is independent from the PDCCH monitoring including a transport channel or a control channel of the MBS multicast transmission, and
the collision handling rule for the type OB common search space set and a type 0 common search space set collision handling rule are defined separately.

18. The network entity of claim 14, wherein:
the collision handling rule defines the action as performing the uplink transmission when a communication type of the uplink transmission is a dedicated-radio resource control (RRC)-configured uplink transmission,
the collision handling rule is independent from the PDCCH monitoring including a transport channel or a control channel of the MBS multicast transmission, and
the collision handling rule for the type OB common search space set and a type 0 common search space set collision handling rule are defined separately.

19. The network entity of claim 14, wherein:
the collision handling rule defines the action as an error condition when a communication type of the uplink transmission is a dedicated-radio resource control (RRC)-configured uplink transmission and when the PDCCH monitoring includes a control channel of the MBS multicast transmission and defines the action as based on implementation of the network entity when the communication type is the dedicated-RRC-configured uplink transmission and when the PDCCH monitoring includes a transport channel of the MBS multicast transmission, and
the collision handling rule for the type OB common search space set and a type 0 common search space set collision handling rule are defined jointly.

20. The network entity of claim 19, wherein the error condition is an assumption regarding non-occurrence of a collision between the PDCCH monitoring in the type OB common search space set and the uplink transmission.

21. The network entity of claim 14, wherein:
the collision handling rule defines the action as based on implementation of the network entity when a communication type of the uplink transmission is a non-dedicated-radio resource control (RRC)-configured uplink transmission,
the collision handling rule is independent of the PDCCH monitoring including a transport channel or a control channel of the MBS multicast transmission, and
the collision handling rule for the type OB common search space set and a type 0 common search space set collision handling rule are defined jointly.

22. The network entity of claim 14, wherein:
the collision handling rule defines the action as an error condition when a communication type of the uplink transmission is a dedicated-radio resource control (RRC)-configured uplink transmission and when the PDCCH monitoring includes a transport channel of the MBS multicast transmission and defines the action as based on implementation of the network entity when the communication type is the dedicated-RRC-configured uplink transmission and when the PDCCH monitoring includes a control channel of the MBS multicast transmission, and
the collision handling rule for the type OB common search space set and a type 0 common search space set collision handling rule are defined jointly.

23. The network entity of claim 22, wherein the error condition is an assumption regarding non-occurrence of a collision between the PDCCH monitoring in the type OB common search space set and the uplink transmission.

24. The network entity of claim 14, wherein:
the collision handling rule defines the action as based on implementation of the network entity,
the collision handling rule is independent from a communication type of the uplink transmission,
the collision handling rule is independent from the PDCCH monitoring including a transport channel or a control channel of the MBS multicast transmission, and
the collision handling rule for the type OB common search space set and a type 0 common search space set collision handling rule are defined jointly.

25. The network entity of claim 1, wherein the network entity is a user equipment (UE).

26. The network entity of claim 1, wherein the collision condition is a potential collision condition.

27. The network entity of claim 1, wherein the collision condition is an actual collision condition.

28. The network entity of claim 1, wherein the collision condition exists between the type OB common search space set for the PDCCH monitoring and the uplink transmission based on a temporal overlap between the type OB common search space set for the PDCCH monitoring and the uplink transmission.

29. The network entity of claim 1, wherein:
the type OB common search space set for the PDCCH monitoring is within a first time period and the uplink transmission is scheduled to occur during a second time period, and
the collision condition exists between the type OB common search space set for the PDCCH monitoring and the uplink transmission based on an overlap of the first time period and the second time period.

30. The network entity of claim 1, wherein:
operations in the half-duplex mode are associated with frequency division multiplexing (FDD) operations, and
the PDCCH monitoring of the type OB common search space set and the uplink transmission are in a paired spectrum.

31. The network entity of claim 1, wherein the action is only performing the uplink transmission based on occurrence of the collision condition.

32. The network entity of claim 1, wherein the action is only performing the PDCCH monitoring in the type OB common search space set.

33. The network entity of claim 1, wherein the collision condition is an actual collision condition and the network entity selects whether to perform the uplink transmission or to perform the PDCCH monitoring in the type OB common search space set.

34. The network entity of claim 1, wherein the PDCCH monitoring is performed while the network entity is operating in a radio resource control (RRC) inactive state.
